(19) United States
(12) Patent Application Publication
(10) Pub. No.: US 2019/0072897 A1
(43) Pub. Date: Mar. 7, 2019

(54) APPLICATIONS OF DIFFUSE MEDIUM IMAGING

(71) Applicant: Open Water, Inc., San Francisco, CA (US)

(72) Inventors: Mary Lou Jepsen, Sausalito, CA (US); Jae Hyeong Seo, Pleasanton, CA (US); Craig Newswanger, Austin, TX (US); Edgar Emilio Morales Delgado, San Francisco, CA (US); Lindy Brown, Greenbrae, CA (US)

(21) Appl. No.: 16/056,805

(22) Filed: Aug. 7, 2018

Related U.S. Application Data
(60) Provisional application No. 62/545,447, filed on Aug. 14, 2017.
(60) Provisional application No. 62/545,848, filed on Aug. 15, 2017.

(51) Int. Cl. G03H 1/04; G02B 26/12; G02B 7/04; G02B 27/09; G02B 5/32; G02B 26/10

(52) U.S. Cl. CPC G03H 1/0406; G02B 26/128; G02B 26/106; G02B 27/0955; G02B 5/32; G02B 7/04

(57) ABSTRACT

Methods and apparatus are configured for focusing and imaging of translucent materials with decreased size and complexity and improve resolution. The methods and apparatus provide improved focusing and imaging with decreased size and weight, so as to allow use in many fields.

### CROSS-REFERENCE

The present application claims priority to U.S. Provisional Patent Application No. 62/545,447, filed on Aug. 14, 2017, entitled “APPLICATIONS OF DIFFUSE MEDIUM IMAGING”, and U.S. Provisional Patent Application No. 62/545,848, filed on Aug. 15, 2017, entitled “APPLICATIONS OF DIFFUSE MEDIUM IMAGING”, the entire disclosures of which are incorporated herein by reference for all purposes. The subject matter of the present application is related to U.S. application Ser. No. 15/264,088, filed on Sep. 13, 2016, entitled “Optical Imaging of Diffuse Medium”, the entire disclosure of which is incorporated herein by reference for all purposes.

### BACKGROUND

Prior approaches to focusing light and imaging translucent objects can be less than ideal in at least some respects. For example, translucent objects can be difficult to image with light. Although holography and spatial light modulators have been proposed for focusing light, these prior approaches can be overly complex, somewhat sensitive to alignment, and less than ideally suited for use with many applications. Also, some of the prior approaches can be somewhat bulky and larger than would be ideal. For example, some of the prior approaches have relied on relatively large optical components, which can decrease the size and weight of these approaches. While there are many potential applications for focusing and imaging of light through translucent materials such as astronomy, autonomous vehicles, healthcare and military applications, the prior approaches have limited the usefulness of this approach in at least some instances.

As an example, rising healthcare costs put economic pressure on families and businesses in addition to constraining access to healthcare to those that can afford the increased cost. Some modes of medical imaging are large cost drivers in medical expenses since the systems and devices that facilitate the medical imaging are valued in the millions of dollars. As a result of the high price of some medical imaging systems, alternative testing and/or less accurate modes of medical imaging are standard-of-care, even though the more expensive medical imaging system is a better diagnostic tool. In developing nations, the high price of medical imaging systems such as MRIs (Magnetic Resonance Imaging) limits access to medical imaging because of both price and physical access since the sparse geographical distribution of medical imaging systems also imposes a travel barrier for those that would benefit from them.

In light of the above, improved methods and apparatus for focusing and imaging with light are needed. Ideally such methods and apparatus would be smaller, less complex, and allow use in many applications.

### SUMMARY

The presently disclosure methods and apparatus allow focusing and imaging of translucent materials with decreased size and complexity. The presently disclosed methods and apparatus provide improved focusing and imaging with decreased size and weight, so as to allow use in many fields. In some embodiments, the spatial light modulator comprises at least about a million independently controllable light modulating pixels, which can provide increased resolution and allow focusing, phase conjugation, and scanning over large volumes of the translucent material to be scanned, such as at least a cubic millimeter, at least 100 cubic millimeters, at least a cubic centimeter, or more. In some embodiments, the scanning can be performed without additional lenses such as objective lenses in order to decrease the size, weight and complexity of the system, although the system may comprise lenses if helpful. The light modulating pixels can be spaced by an amount corresponding to a wavelength of light transmitted through the light modulating pixels, and in some embodiments a spacing of the light modulating pixels (e.g. pitch) may comprise no more than about ten times the wavelength of light, such as no more than about five times the wavelength of light or less, in order to provide improved focus, phase conjugation, scanning and imaging, and can allow the spatial light modulator to be used without lenses and with shorter total path lengths in some embodiments. The imaging apparatus may comprise a light source and a spatial light modulator arranged in sequence with a second light source and a detector arranged in sequence, configured to be coupled to the translucent material, so as to image the translucent material, in some embodiments without lenses disposed in between. In some embodiments, the focusing and imaging apparatus is configured to scan a volume of translucent material, in which the volume of translucent material corresponds to a plurality of imaged voxels of an image volume the translucent material. The image volume of the translucent material may comprise any suitable number of voxels, such as at least about 200 voxels along each dimension of a three dimensional image.

Reference is made to the claims below, which provide additional summary of aspects of the present disclosure.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates an example imaging system that includes a display and an image pixel array, in accordance with some embodiments.

FIG. 1B illustrates an example imaging system that includes a temperature sensor and a motion sensor, in accordance with some embodiments.

FIG. 2A illustrates an example imaging system that includes a display and an image pixel array operating in a forward scattering mode, in accordance with some embodiments.

FIG. 2B illustrates an example imaging system that includes a display and an image pixel array operating in a back scattering mode, in accordance with some embodiments.

FIG. 3 illustrates example placement of components of an imaging system in relationship to a human head, in accordance with some embodiments.

FIGS. 4A and 4B illustrate example form-factor implementations of a wearable imaging system, in accordance with some embodiments.

FIG. 5 illustrates an example configuration of a flexible wearable imaging system, in accordance with some embodiments.

FIG. 6 illustrates a networked system in communication with an example wearable imaging system for being worn on or about a head, in accordance with some embodiments.

FIGS. 7A-7C illustrate example embodiments of a directional ultrasonic emitter, in accordance with some embodiments.

FIGS. 8A and 8B illustrate example embodiments of displays for generating holographic infrared imaging signals, in accordance with some embodiments.

FIG. 9 illustrates an example process of linking a holographic pattern to a location in a diffuse medium, in accordance with some embodiments.

FIG. 10 illustrates an example imaging system that includes a display and an image pixel array, in accordance with some embodiments.

FIG. 11 illustrates an example process of linking a holographic pattern to a location in a diffuse medium, in accordance with some embodiments

FIG. 12 shows a small area scanner having the form factor of a puck, in accordance with some embodiments.

FIG. 13 shows a pelvic diagnostic device having the form factor of a stool or chair, in accordance with some embodiments.

FIG. 14 shows a full-body diagnostic device having the form factor of a bed, in accordance with some embodiments.

FIG. 15 shows a handheld medical diagnostic device having the form factor of a tablet, in accordance with some embodiments.

FIG. 16 shows a shoe fitting device, in accordance with some embodiments.

FIG. 17 shows a system for stimulating vision in a subject, in accordance with some embodiments.

FIG. 18 shows a system for controlling a wheelchair based on a subject's thoughts, in accordance with some embodiments.

FIG. 19 shows a system for non-destructively testing a printed circuit board, in accordance with some embodiments.

FIG. 20 shows a system for 3D printing of optically translucent materials, in accordance with some embodiments.

FIG. 21 shows a handheld imaging device, in accordance with some embodiments.

FIG. 22 illustrates an exemplary digital processing device programmed or otherwise configured with an imaging device, in accordance with some embodiments.

### DETAILED DESCRIPTION

Embodiments of systems, devices, and methods for optical imaging of a diffuse medium are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

The content of this disclosure may be applied to many fields, such as medical imaging, autonomous vehicles, marine imaging, atmospheric imaging, light detection and ranging (LIDAR), military applications, construction, paints, structural integrity engineering, and human computer interfaces. Human tissue is generally translucent to infrared light, although different parts of the human body (e.g. skin, blood, bone) exhibit different absorption coefficients. Researchers have attempted to use the properties of infrared light for medical imaging purposes, but size and cost constraints have been prohibitive for wide-scale adoption. Illuminating tissue with near-infrared light for imaging purposes is sometimes referred to as Diffuse Optical Tomography. In one Diffuse Optical Tomography technique, time-of-flight (TOF) imaging can theoretically be employed by measuring the time it takes for “ballistic” photons (those photons that are not scattered) to pass through tissue. Since the ballistic photons reach the sensor the fastest, they are the least impeded (have the shortest optical path) and thus some conclusion can be drawn to create an image of the tissue that is illuminated by infrared light. However, TOF imaging generally requires specialty hardware (e.g. picosecond pulsed lasers and single photon detectors) to facilitate ultrafast shutters on sensors that are able to image at the speed of light and the systems are overall very expensive and bulky. TOF imaging also requires an input of approximately 10-100 fold (or more) light intensity into the body than is used at the detector; thus efficacy and power limitations as well as safety limits on input intensity limit TOF imaging resolution and utility. In contrast to TOF imaging, embodiments of this disclosure utilize a holographic beam to direct infrared light to a voxel of a diffuse medium (e.g. a brain or tissue). A light detector (e.g. image pixel array) measures an exit signal of the holographic beam. The exit signal is the infrared light of the holographic beam that is reflected from and/or transmitted through the voxel. The light detector may include a pixel array that measures the amplitude and determines the phase of the exit signal that is incident on the pixels. By capturing an image of the exit signal changes (e.g. oxygen depletion in red blood cells, scattering changes induced by potential differences in an activated neuron, fluorescent contrast agents and other optical changes) at a voxel or group of voxels in the diffuse medium, changes to that voxel or group of voxels can be recorded over time as the absorption, phase of scattering of the holographic beam varies with the changes in the tissues. Multiple voxels can be imaged by changing a holographic pattern on a display to steer the holographic beam toward the different voxels or groups of voxels. By raster scanning through many voxels (and recording the exit signals), a three dimensional image of the diffuse medium can be constructed. The methods and apparatus disclosed herein are well suited for combination with these aforementioned approaches.

Reference throughout this specification to “one embodiment”, “an embodiment”, or “some embodiments” means that a particular feature, structure, or characteristic described may be included in at least one embodiment of the present invention, and each of these embodiments may be combined with other embodiments in accordance with the present disclosure. Thus, the appearances of the phrases “in one embodiment”, “in an embodiment”, or “in some embodiments” throughout this specification do not necessarily all refer to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise. Also, like characters generally refer to like elements unless indicated otherwise.

The imaging systems as described herein can focus light to locations within the translucent material. In some embodiments, the holographic pattern written on the display is configured to focus light to the plurality of locations, and may comprise optical power. This can decrease reliance on additional optics such as microscope objectives, and can decrease the size and complexity of the system and can allow the system to be configured with a compact form factor as described herein.

The plurality of holographic patterns may comprise phase conjugates configured to focus the light at the plurality of locations, and the plurality of holographic patterns may correspond to optical power to focus the light to the plurality of locations. For example, the plurality of holographic patterns correspond to sufficient optical power to focus the light to the plurality of locations at a plurality of distances from a the spatial light modulator and optionally wherein each of the plurality of distances comprises no more than a meter and the sufficient optical power comprises at least a Diopter, corresponding to focusing light at a distance of no more than one meter in the translucent material. The sufficient optical power may comprise at least 5 Diopters, corresponding to a distance focusing light at a distance of no more than one meter from the spatial light modulator such as the display as described herein. The light can be focused with the plurality of holographic patterns without a lens such as microscope objective lens.

The plurality of holographic patterns may comprise a phase conjugate for each of the plurality of locations, and each of the plurality of phase conjugates may comprise a predetermined phase conjugate stored on a memory of the processor, and optionally wherein the processor comprises instructions to write the plurality of phase conjugates to the spatial light modulator.

The plurality of phase conjugates can be generated in real time, or at least sufficiently quickly so as to be used to image a dynamically changing translucent medium such as the atmosphere, sea water, or tissue, for example within a minute or less, a few seconds or less, or within 100 milliseconds or less.

Light focused with the plurality of phase conjugates to the plurality of locations can be imaged with the detector, and an image captured for each of the plurality of phase conjugates at each of the plurality of locations. The image for each of the plurality of locations can be generated in many ways. For example, light focused with the phase conjugate can be received at the detector along with light from a reference beam such as a second light source, and the resulting interference pattern can be used to determine the amplitude and the phase of the light received from the focused location in the tissue. The amplitude and phase of the light received at the detector can be used to reconstruct an image of light at the focused location. The reconstructed image may comprise a plurality of pixels comprising amplitudes of light transmitted through the focused location, or a plurality of pixels comprising phases of light transmitted through the focused location, and combinations thereof (e.g. amplitudes and phases of light for each pixel of the image of light transmitted through the focused location). In some embodiments, the spatial frequencies of light in the reconstructed image comprise frequencies greater than frequencies corresponding to the size of the focused light spot, such that the reconstructed image may comprise spatial frequencies greater than spatial frequencies corresponding to the size of the focused light spot generated with the phase conjugate. Also, the reconstructed image may comprise resolution finer than the focused beam diameter. The additional resolution can be combined with reconstructed images to generate 3D volumetric images comprising spatial frequencies greater than the resolution of the focused light spot and resolution finer than the size of the focused light spot.

The spatial light modulator and holographic pattern written onto the plurality of pixels can be configured in many ways to measure the amplitude and phase of light received from the translucent material at the detector. For example, the holographic pattern can be phase modulated, e.g. with phase stepping, so as to generated a plurality of phase modulated images on the detector, each corresponding to a different phase of the holographic pattern. In specific embodiments, the holographic pattern may comprise a modulo 2π phase pattern, and the phase of the pattern uniformly modulated by (2/3)*π between each of a plurality of three holographic patterns (e.g. by adding (2/3)*π to the phase of each pixel of the spatial light modulator), in order to generate a plurality of phase modulated detector images. The phase modulated detector images can be used to determine the amplitude and phase of light received from the translucent medium. Alternatively or in combination, the phase of the reference light source can be adjusted and combined with light from the translucent material to generate the plurality of phase modulated images at the detector.

Alternatively or in combination with imaging with a reference beam or phase modulation, a lens can be used with the detector to image the translucent medium at the location through which light is focused onto the detector. The lens may comprise a holographic optical element, diffractive optical element or geometric (bulk) lens such as an objective lens (e.g. microscope objective lens), and the use of a lens is optional. Work in relation to embodiments suggests that high spatial resolution images can be achieved without lenses, and the size of the device reduced accordingly.

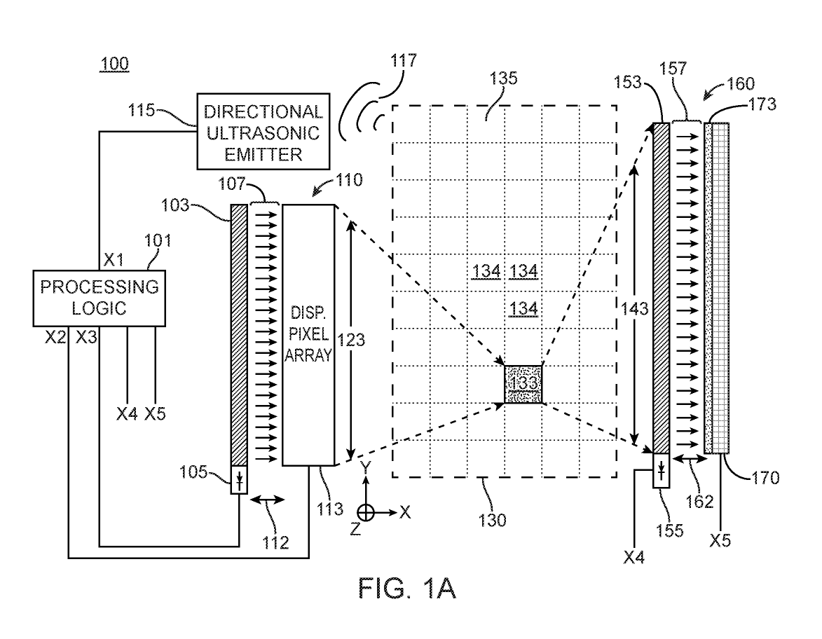

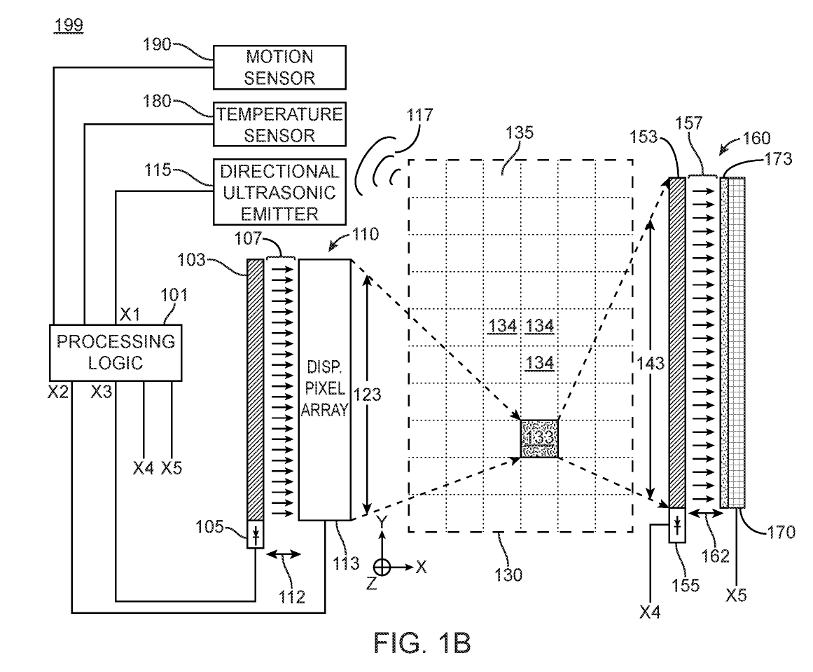

FIG. 1A illustrates an example imaging system 100, in accordance with an embodiment of the disclosure. Imaging system 100 includes processing logic 101, a display 110, and an image pixel array 170. In FIG. 1A, imaging system 100 also includes a directional ultrasonic emitter 115 coupled to be driven by processing logic 101. In FIG. 1A, display 110 includes an infrared emitter 105, an infrared director 103, and a display pixel array 113. Display pixel array 113 may be an LCD (liquid crystal display), for example. The LCD display may be an active-matrix (using thin-film-transistors) or a passive matrix LCD. In some embodiments, the LCD display comprises pixels that are less than 7 microns.

In some embodiments, display 110 is a holographic display. For the purposes of this disclosure, a holographic display includes a display where each pixel of the display can independently modulate the phase and intensity of light that illuminates the pixel. The array of pixels may utilize a transmissive architecture (e.g. modulating transmission through liquid crystal) or a reflective architecture (e.g. Liquid Crystal on Silicon).

Processing logic 101 may include a processor, microprocessor, cluster of processing cores, FPGA (field programmable gate array), and/or other suitable combination of logic hardware. Although not illustrated, system 100 may include a wireless transceiver coupled to processing logic 101. The wireless transceiver is configured to wirelessly send and receive data. The wireless transceiver may utilize any suitable wireless protocol such as cellular, WiFi, BlueTooth™, or otherwise.

In FIG. 1A, display pixel array 113 is illustrated as a transmissive LCD that is illuminated by infrared wavefront 107. In the illustrated embodiment, infrared (IR) emitter 105 is coupled to be driven by output X3 of processing logic 101. When processing logic 101 turns on IR emitter 105, infrared light propagates into IR director 103. IR director 103 may be a light guide plate similar to those found in conventional edge lit LCDs. IR director 103 may be a slim prism utilizing TIR (total internal reflection). IR director 103 redirects the infrared light toward display pixel array 113. IR director 103 may include a saw tooth grating to redirect the infrared light toward IR display 113. IR emitter 105 is an infrared laser diode that emits monochromatic infrared light, in one embodiment. Alternatively or in combination, the display may comprise micro-LEDs coupled to the spatial light modulator. Monochromatic light may be defined as light having a range of wavelengths that lie within a narrow wavelength band. For instance, monochromatic light may have a range of wavelengths within a 0.1 nm wavelength band, a 0.2 nm wavelength band, a 0.5 nm wavelength band, a 1 nm wavelength band, a 2 nm wavelength band, a 5 nm wavelength band, or a 10 nm wavelength band, for example. Monochromatic light may have a range of wavelengths within a wavelength band that is within a range defined by any two of the preceding values. IR emitter 105 in one embodiment is pulsed, and in another embodiment is CW (continuous wave). The light source such as IR emitter 105 may comprise a combination of continuous wave and optical switching, for example. The infrared light that IR emitter 105 emits may be centered around a frequency in the 700-1000 nm range. In some embodiments, the infrared light that IR emitter 105 emits may be centered around a frequency in the 1600-1700 nm range. In one example, emitter 105 generates monochromatic light centered around 850 nm.

Steerable infrared beams can be generated by display 110 by driving different holographic patterns onto display 110. Each different holographic pattern can steer (focus) the infrared light in a different direction. The directional nature of the infrared beam is influenced by the constructive and destructive interference of the infrared light emitted from the pixels of display 110. As an example, a holographic pattern that includes different “slits” at different locations can generate different infrared beams. The “slits” can be generated by driving all the pixels in the display pixel array 113 to “black” (not transmissive) except for the pixels where the “slits” are located are driven to be “white” (transmissive) to let the infrared light propagate through. In some embodiments, the pixel size of display 110 approximates the wavelength of light illuminating the display. The pixel size may be 1 micron, although in some embodiments pixels sized up to 5 times, 10 times, 50 times, or 100 times the wavelength of light can be used. Pixels sized up to within a range defined by any two of the preceding values can be used. In one example, if IR emitter 105 is an 850 nm laser diode, the pixel size of display 110 may be 850 nm. The pixel size influences the angular spread of a hologram since the angular spread is given by the Grating Equation:

sin(θ)=mλ/d (Equation 1)

where θ is the angular spread of light, m is an integer number and the order of diffraction, and d is the distance of two pixels (a period). Hence, smaller pixel size generally yields more design freedom for generating holographic beams, although pixels sizes that are greater than the wavelength of light can also be used to generate holographic imaging signals. Display pixel array 113 may include square pixels (rather than the rectangular pixels in conventional RGB LCDs) so that the Grating Equation is applicable in both the x and y dimensions of the pixel array.

In FIG. 1A, system 100 includes an ultrasonic emitter 115. Ultrasonic emitter 115 is configured to focus an ultrasonic signal to a point in three-dimensional space. In the medical context, the ultrasonic emitter 115 is configured to focus an ultrasonic signal to a voxel within the human body. The voxel may be within the brain, abdomen, or uterus, for example. Focusing an ultrasonic signal to a given voxel of tissue creates a (temporary) localized compression zone at the voxel. In turn, the localized compression zone affects the propagation of infrared light through the localized compression zone. In particular, the phase of infrared light is modulated as a result of the localized compression of the tissue. As will be discussed in more detail below, the change of phase at the localized compression zone can be measured in a way that assists imaging tissue, or other diffuse mediums. Processing logic 101 is coupled to drive directional ultrasonic emitter 115 to focus ultrasonic signal 117 to different locations in three-dimensional space via output X1, in the illustrated embodiment. The directional ultrasonic emitter 115 can be driven to focus an ultrasonic signal to voxel 133 in three-dimensional diffuse medium 130, for example. Ultrasonic signal 117 may be focus using phased array ultrasonic beam steering techniques. The three dimensional diffuse medium 130 may comprise a plurality of voxels 134, and the region of tissue scanned and imaged may comprise a volume 135 of the three dimensional translucent material. The light beam can be scanned to a plurality of locations corresponding to the plurality of voxels.

Imaging module 160 is positioned to image exit signal 143, in FIG. 1A. As infrared holographic imaging signal 123 propagates through diffuse medium 130 and at least a portion of it propagates through voxel 133 and exits diffuse medium 130 as exit signal 143. Exit signal 143 is a transmission signal in that imaging module 160 is imaging the transmission of infrared holographic imaging signal 123 through voxel 133. Reflective transmission signals (the reflection of holographic imaging signal 123 from voxel 133) may be measured in other embodiments.

Imaging module 160 includes IR emitter 155, IR director 153, and image pixel array 170. IR emitter 155 is coupled to receive an activation signal from processing logic 101 by way of output X4. IR emitter 155 emits an infrared light that shares the same characteristics as the infrared light emitted by IR emitter 105. IR emitter 105 and IR emitter 155 may be identical emitters. In some embodiments, instead of having separate emitters for IR emitter 105 and IR emitter 155, fiber optic lines direct infrared light from a shared IR emitter to IR director 103 and IR director 153. In this embodiment, when processing logic 101 activates the IR emitter, the infrared light emitted by the IR emitter travels through the fiber optics to illuminate both IR director 103 and 153. IR director 153 redirects the IR light emitted by IR emitter 155 toward image pixel array 170 as reference wavefront 157. IR emitter 155 paired with IR director 153 is one example of a reference wavefront generator for generating reference wavefront 157. IR director 153 may be made from a transparent plastic or glass such that IR director 153 is transparent to (or distorts in a known way) exit signal 143 that encounters IR director 153. IR director 153 may include a diffractive grating that is tuned to redirect the infrared light from IR emitter 153 toward image pixel array 170. The diffractive grating can be embedded within a transparent material of the IR director 153 so that it redirects a specific wavelength of IR light received from a particular angle (e.g. same angle as the IR emitter 155 is positioned) but is otherwise transparent to (or distorts in a known way) exit signal 143 since exit signal 143 is not incident upon the diffractive grating at the same angle as the IR light emitted by IR emitter 155. In some embodiments, IR director 153 includes a light guide plate as used in most liquid crystal display systems.

The ultrasonic emitter can be configured to generate a frequency shift of light at a location of the focused ultrasound beam, in which the frequency shift corresponds to a photon-phonon interaction of light with the ultrasound wave. The display comprising the spatial light modulator module, the detector module, and the ultrasound source can be arranged in order to selectively measure frequency shifted light at the location of the focused ultrasound beam. The second light source of the detector imaging module can be appropriately frequency shifted in order to selectively image frequency shifted light from the location where the ultrasound beam is focused. For example, light from the second light source such as the second IR director can be frequency shifted to provide interference with the light emitted from the sample, such that light from the focused ultrasound beam is selectively measured and imaged with the imaging detector module. The ultrasound beam can be selectively scanned to a plurality of voxel locations within the imaged volume, and a plurality phase conjugates generated for each of the plurality of locations and corresponding voxels in response to the frequency shifted light. The reference wavefront from the second light source can be frequency shifted in many ways as is known to one of ordinary skill in the art, such as with acousto-optic modulation, for example.

In the illustrated embodiment, an infrared filter 173 is disposed between IR director 153 and image pixel array 170. Infrared filter 173 passes the wavelength of infrared light emitted by IR emitters 105 and IR emitter 155 and rejects other light wavelengths that image pixel array 170 is sensitive to. Infrared filter 173 may be a bandpass filter with a bandwidth of four nanometers centered around the frequency of monochromatic IR light emitted by emitters 105 and 155. Although not illustrated, a focusing lens may be disposed between image pixel array 170 and IR director 153. The focusing lens may be configured to focus reference wavefront 157 and exit signal 143 such that the interference patterns of reference wavefront 157 and exit signal 143 are well focused on pixels of image pixel array 170 such that there is sufficient resolution for analysis of the interference patterns.

Image pixel array 170 may be implemented with an a-Si (amorphous Silicon) thin film transistors, in some embodiments or a CMOS (Complementary Metal-Oxide-Semiconductor) image sensor, in some embodiments. Image pixel array 170 can be a commercially available image sensor, or optimized for detecting differences in signal rather than the maximum dynamic range of the signal, as for example as shown in by K. P. Hofmann and D. Emeis “Differential Light Detector” Rev. Sci Instrum 50, 249 1979, or in the case of detecting the change of holographic fringe patterns use processing logic 101 suited for detecting shifts in patterns.

The pixel resolution of image pixel array 170 may vary depending on the application. In some embodiments, the image pixel array 170 is 1920 pixels by 1080 pixels. In some embodiments, the image pixel array is 40 Megapixels or more. Some of the processing can be done in the image pixel array itself to enable lower bandwidth connections off chip. Image pixel array 170 can capture an infrared image of exit signal 143 by measuring the image charge generated in each pixel during a given integration period that is determined by an electronic shutter. Alternatively or in combination, the integration time may be controlled by a mechanical shutter. The electronic shutter may be a global shutter (where each pixel measures the incident light during a same time period) rather than a rolling shutter. The electronic shutter can be actuated by processing logic 101 via input/output X5. Input/output X5 may include digital input/output lines as well as a data bus. Image pixel array 170 is communicatively coupled to processing logic 101 to send the captured infrared images to processing logic 101 for further processing. Image pixel array 170 may include a local (on-board) digital signal processor (DSP), in some embodiments, and processing logic 101 may receive the captured infrared images from the DSP.

In addition to capturing the amplitude of incident infrared light, the phase of incident infrared light can be determined from recording interference patterns using imaging module 160. The amplitude (intensity) of incident infrared light is measured by simply reading out the image charge accumulated in each photosensor (e.g. photodiode) of the pixels of image pixel array 170. The phase of light from exit signal 143 can also be measured by activating IR emitter 155 during the integration period of pixels of image pixel array 170. Since exit signal 143 is the same monochromatic wavelength as reference wavefront 157, the light interference of the exit signal 143 and the reference wavefront 157 indicates the phase of the infrared light of exit signal 143. The interference patterns created by the interference of exit signal 143 and reference wavefront 157 will be recorded by the image pixel array 170. The interference patterns can be analyzed to determine the phase of exit signal 143. The phase of and/or amplitude of different exit signals 143 can be analyzed to determine a suitable holographic pattern to image a given voxel (e.g. voxel 133).

One example process of linking a holographic pattern for driving onto display 110 to a given voxel utilizes directional ultrasonic emitter 115. To start this example process of linking a preferred holographic pattern (for driving onto display 110) to a given voxel in a diffuse medium, image pixel array 170 may initiate two image captures when an initial holographic pattern is driven onto display 110. The first image capture measures the amplitude of exit signal 143 by measuring the infrared light from exit signal 143 interfering with the light from reference wavefront 157 while the directional ultrasonic emitter 115 of FIG. 1A is off and thus captures the exit signal 143 with no phase change induced in voxel 133 by ultrasonic emitter 115. The phase of exit signal 143 can also be determined by analyzing the amplitude of different pixel groups that show interference patterns of exit signal 143 interfering with reference wavefront 157. The second image capture measures the interference of reference wavefront 157 with exit signal 143 when directional ultrasonic emitter 115 is activated and focused on voxel 133. As with the first image capture, both the amplitude and phase of exit signal 143 can be determined from the second image capture. Since the ultrasonic signal 117 locally compresses voxel 133 and induces a phase change of light propagating through the voxel 133, the first image capture and the second image capture will be different when the holographic pattern that is driven onto display 110 propagates through voxel 133. When the difference between the first image capture and the second image capture is increased (to an acceptable level), the holographic pattern driven onto display 110 can be said to best focus on voxel 133 and is the preferred holographic pattern and thus linked to the voxel. Therefore, after the difference between the first and second image capture with the initial holographic pattern driven onto display 110 is calculated, the initial holographic pattern may be iterated to determine if a second holographic pattern driven on display 110 generates an even greater difference (measured by amplitude and/or phase) between a first and second image capture. Signal 123 is altered by driving a different holographic pattern on display 110, via for example simulated annealing, to maximize the difference between the first image capture and the second image capture. The holographic pattern may be iterated many times while seeking the largest change between the first and second image capture. This technique is used to create a dictionary (i.e. lookup table) of holographic patterns (corresponding to input signal 123) to map to focus the light sequentially to one or more voxels and to enable raster scanning of the volume, one voxel at a time. The first and second image capture may occur successively, one immediately after the other, to limit any change in exit signal 143 between image captures due to changes in diffuse medium 130.

FIG. 1B illustrates an example imaging system 199 that includes a temperature sensor and a motion sensor, in accordance with some embodiments. Imaging system 199 may comprise components of imaging system 100 and can be similar in many regards. For instance, imaging system 199 may comprise some or all of the elements of imaging system 100. Imaging system 199 may further comprise a temperature sensor 180. The temperature sensor may be a thermistor, thermocouple, solid-state temperature sensor, resistive temperature sensor, capacitive temperature sensor, pyroelectric temperature sensor, thermal diode, or any other temperature sensor as is known to one having skill in the art. The temperature sensor may be operatively coupled to processing logic 101. The temperature sensor may be thermally coupled to diffuse medium 130 (such as biological tissue). The temperature sensor may measure or record a temperature of the diffuse medium, and may be located near an exterior surface of the imaging system to couple preferentially to the diffuse medium. Alternatively or in combination, the temperature sensor or a plurality of temperature sensors may be thermally coupled to any of the components of imaging system 199. For instance, the temperature sensor may be thermally coupled to IR director 103, IR emitter 105, display pixel array 113, directional 115, IR director 153, IR emitter 155, imaging module 160, image pixel array 170, or filter 173. The temperature sensor may measure or record a temperature of any of the components of imaging system 199. The temperature sensor may send a measurement or recording of the temperature of any of the components of imaging system 199 to processing logic 101. The processing logic may correct an output or response of the component of imaging system 199 based on the measurement or recorded temperature and a model or calibration curve. For instance, the processing logic may correct optical signals received by image pixel array 170 based on the temperature of the image pixel array and a model of the image pixel array's detection response to light at different operating temperatures of the image pixel array.

The temperature of the imaged object such as tissue can be similarly recorded and corrections made, and the temperature compensation can be configured in many ways so as to correct for changes in the optical path related to temperature. In some embodiments, the mapped physical location of the tissue is adjusted in response to the measured temperature of the tissue in accordance with the index of refraction of tissue associated with temperature, so as to more accurately determine locations of the mapped tissue structures.

Imaging system 199 may comprise a plurality of temperature sensors. Imaging system 199 may comprise 1, 2, 3, 4, 5, 6, 7, 8, 9, 10, or more than 10 temperature sensors. Each temperature sensor of the plurality of temperature sensors may be thermally coupled to a different component of imaging system 199 or the object being measured, for example thermally coupled to the object being measured such as a plurality of exterior locations of the object being measured. A first temperature sensor may be thermally coupled to IR director 103. A second temperature sensor may be thermally coupled to IR emitter 105. A third temperature sensor may be thermally coupled to display pixel array 113. A fourth temperature sensor may be thermally coupled to directional ultrasonic emitter 115. A fifth temperature sensor may be thermally coupled to IR director 153. A sixth temperature sensor may be thermally coupled to IR emitter 155. A seventh temperature sensor may be thermally coupled to imaging module 160. An eighth temperature sensor may be thermally coupled to image pixel array 170. A ninth temperature sensor may be thermally coupled to filter 173. Any of the first, second, third, fourth, fifth, sixth, seventh, eight, or ninth temperature sensors may send a measurement or recording of the temperature of the component of imaging system 199 to which it is thermally coupled to processing logic 101. The processing logic may correct an output or response of each component based on the measured or recorded temperature and a model or calibration curve.

Imaging system 199 may further comprise a motion sensor 190. The motion sensor may be operatively coupled to processing logic 101. The motion sensor may comprise a position sensor, orientation sensor, velocity sensor, angular velocity sensor, accelerometer, angular accelerometer, gyroscope, or any other motion sensor that detects a movement, a position, or an orientation as is known to one having skill in the art, and the position sensor may comprise a 3 axis accelerometer or a 3 axis gyroscope, for example. The motion sensor may be coupled to diffuse medium 130 (such as biological tissue). The motion sensor may measure or record a position, orientation, velocity, angular velocity, acceleration, or angular acceleration of the diffuse medium. The motion sensor may be coupled to any of the components of imaging system as described herein. For instance, the motion sensor may be coupled to IR director 103, IR emitter 105, display pixel array 113, directional 115, IR director 153, IR emitter 155, imaging module 160, image pixel array 170, or filter 173. The motion sensor may measure or record a position, orientation, velocity, angular velocity, acceleration, or angular acceleration of any of the components of imaging system 199. The motion sensor may send a measurement or recording of the position, orientation, velocity, angular velocity, acceleration, or angular acceleration of any of the components of imaging system 199 to processing logic 101. The processing logic may correct an output or response of the component of imaging system 199 based on the measured or recorded position, orientation, velocity, angular velocity, acceleration, or angular acceleration and a model or calibration curve. For instance, the processing logic may correct optical signals received by image pixel array 170 based on the position, orientation, velocity, angular velocity, acceleration, or angular acceleration of the image pixel array and a model of the image pixel array's detection response to light at different position, orientation, velocity, angular velocity, acceleration, or angular acceleration of the image pixel array.

Imaging system 199 may comprise a plurality of motion sensors, such as position sensors, accelerometers, vibration sensors, acoustic sensors. The processor can be configured to detect motion and determine if the object being measured has moved and to appropriately filter the data, for example. The motion data can be integrated and combined to detect motion patterns and make appropriate corrections. The motion sensors can be configured in many ways, for example so as to determine the 3D position and orientation of each of the plurality of spatial light modulator modules and detector modules as described herein. Alternatively or in combination, the 3D position and orientation data can be combined with 3D position and orientation data from the display, such as a light field display (e.g. goggles or tablet display), in order to present 3D image data to a user such that locations of the structure of the 3D image shown to the user correspond to the 3D physical locations of the structure, e.g. registers or matches the virtual locations shown on the display to the physical locations. This can create the perception that the user is looking into the subject.

Imaging system 199 may comprise 1, 2, 3, 4, 5, 6, 7, 8, 9, 10, or more than 10 motion sensors. The plurality of motion sensor can be coupled to a plurality of modules in order to determine a position or orientation of said each of the plurality of modules. Each motion sensor of the plurality of motion sensors may be coupled to a different component of imaging system 199. For instance, a first motion sensor may be coupled to IR director 103. A second motion sensor may be coupled to IR emitter 105. A third motion sensor may be coupled to display pixel array 113. A fourth motion sensor may be coupled to directional ultrasonic emitter 115. A fifth motion sensor may be coupled to IR director 153. A sixth motion sensor may be coupled to IR emitter 155. A seventh motion sensor may be coupled to imaging module 160. An eighth motion sensor may be coupled to image pixel array 170. A ninth motion sensor may be coupled to filter 173. Any of the first, second, third, fourth, fifth, sixth, seventh, eight, or ninth motion sensors may send a measurement or recording of the position, orientation, velocity, angular velocity, acceleration, or angular acceleration of the component of imaging system 199 to which it is coupled to processing logic 101. The processing logic may correct an output or response of each component based on the measured or recorded position, orientation, velocity, angular velocity, acceleration, or angular acceleration and a model or calibration curve.

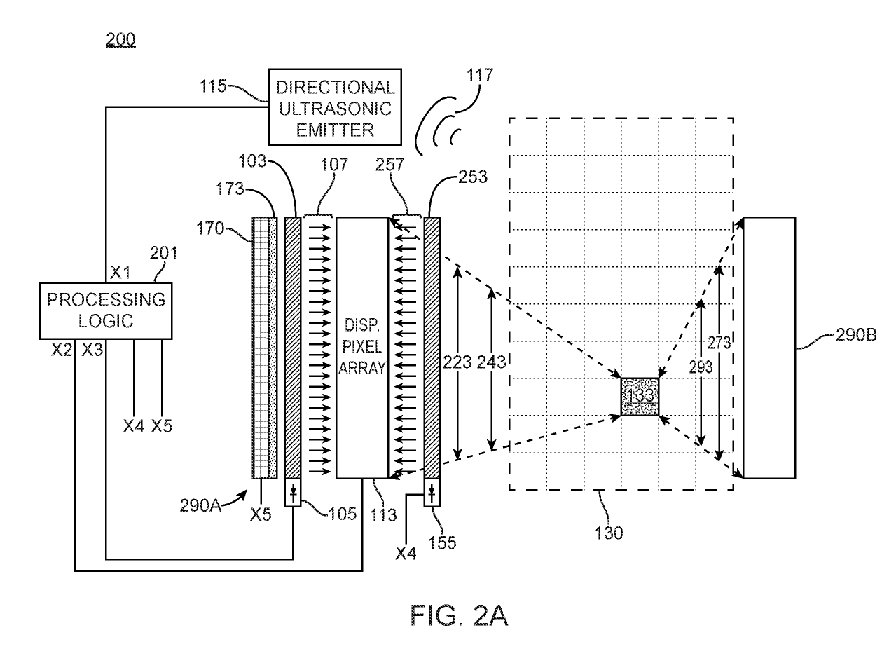

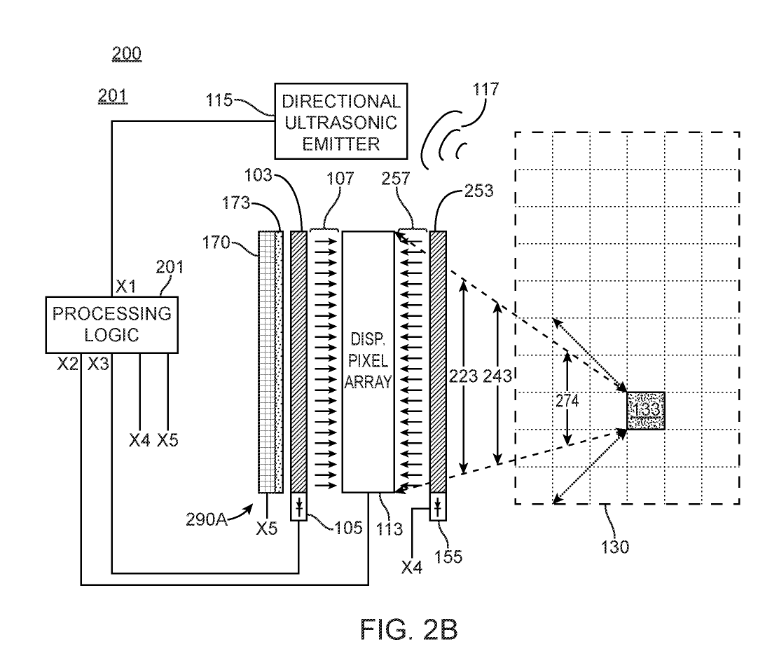

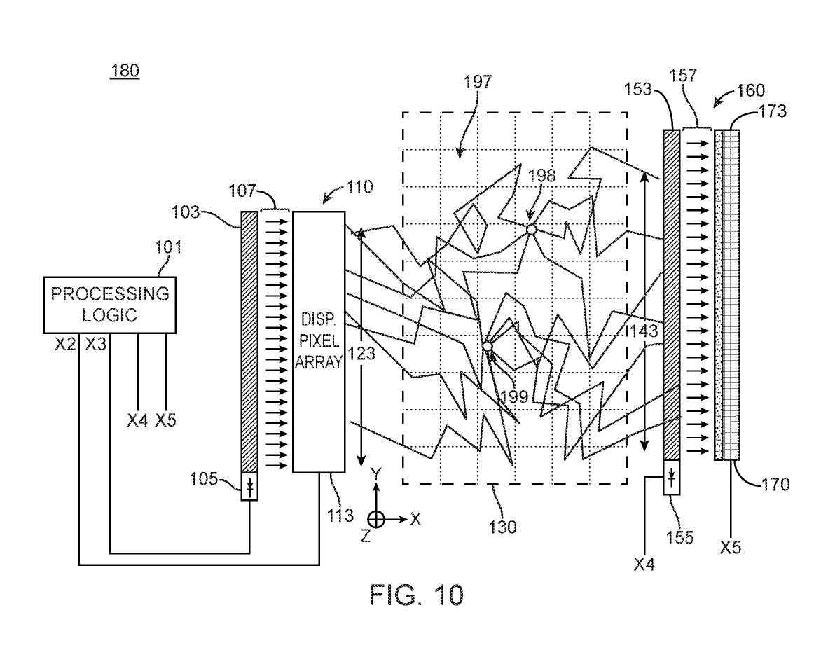

In system 180 illustrated in FIG. 10, imaging module 160 is positioned to image exit signal 143, similarly to in FIG. 1A. However, system 180 of FIG. 10 does not include a directional ultrasonic emitter 115. Infrared holographic imaging signal 123 still propagates through diffuse medium 130 and exits diffuse medium 130 as exit signal 143. In FIG. 10, infrared holographic imaging signal 123 is depicted as light that is scattered by diffuse medium 130 while still propagating through the voxel(s) of interest. The scattered light paths of both signal 123 and 143 illustrated in FIG. 10 may be more realistic than the “clean” beams of FIGS. 1 and 2, illustrated for explanation purposes.

The dimensions of the scanned volume of the translucent material correspond to the dimensions of the spatial light modulator in some embodiments. The high resolution spatial light modulator as described herein, e.g. 1,000,000 spatial light modulation pixels or more, can be configured to scan volumes of translucent material in relation to the size of the spatial light modulator. The plurality of locations may comprise locations of an image volume as described herein. The image volume may comprise a maximum dimension across, and the spatial light modulator may comprise a maximum dimension across. The maximum dimension across the image volume may comprise at least about 10% of a maximum dimension across the spatial light modulator. The maximum distance across the image volume along an axis parallel to the spatial light modulator may comprise at least about 20%, 50%, or 100% of the distance across the spatial light modulator. The maximum dimension across the image volume parallel to the spatial light modulator can within a range defined by any two of the following 10%, 20%, 50%, 75%, or 100%, or more.

A process for linking a preferred holographic pattern (for driving onto display 110) to a voxel or a given set of voxels is different for system 180 since system 180 does not include directional ultrasonic emitter 115. For system 180, to start an example process of linking a preferred holographic pattern to a given set of voxels (two of this set are depicted as voxel 199 and voxel 198 in a diffuse medium 130 in FIG. 10), image pixel array 170 may initiate two image captures when an initial holographic pattern is driven onto display 110. The first image capture measures the amplitude of exit signal 143 by measuring the infrared light from exit signal 143 interfering with the light from reference wavefront 157 prior to application or presentation of stimulus 197 and thus captures the exit signal 143. The exit signal 143 may be analyzed for its amplitude alone or by signal 143 interfering with reference wavefront 157. The second image capture measures the effect of stimulus 197. The stimulus 197 is an internal change to a voxel or weighted group of voxels such that light is absorbed, phase retarded or scattered in a different way by that single voxel or group of voxels. In the brain such a change could be created by showing an image to a subject, playing some music to a subject, a request to a subject to think about something, or simply a wait for a change (internal bleeding, tumor growth, etc.) and other examples. Changes to blood that change the optical signal can be detected (deoxygenated blood absorbs light differently than oxygenated blood), blood volume itself can be detected and changes in its vasculature and flow, lipids, water, fat, melanin, and changes in scattering as can be seen in the direct firing pattern of neurons. Activity of neurons is characterized by ion and water fluxes across the neuron membrane inducing a change in membrane potential which can be seen by a change in light scattering as a function of neuron activity on the millisecond time scale. Fluorescent chemicals, nanoparticles placed via injection, injection or other means can also be used as beacons, including 2-photon systems and other methods where the wavelength of light is shifted at the voxel, area of interest or areas of interest. Many stimuli can impart optical changes inside the diffuse medium, these changes themselves, caused by the stimuli can be used as the beacons to tune the holographic image to focus on the region of change. The system can learn over time, akin to the way speech to text systems train on user's speech and grow continually better over time leveraging the data set and other implied and inferred data. Other existing anatomical data, or map data can be added to this model to extract more information and infer more information about the sites of interest. This work leverages techniques in machine learning, neural nets, deep learning, artificial intelligence and so forth.

With the stimulus present exit signal 143, as with the first image capture, both the amplitude and phase of exit signal 143 can be determined from the second image capture. With a stimulus 197 applied/presented for the second image capture, the first image capture and the second image capture will be different when the holographic pattern that is driven onto display 110 propagates through the multiple voxels affected by the stimulus 197. When the difference between the first image capture and the second image capture is maximized (to an acceptable level), the holographic pattern driven onto display 110 can be said to best represent delivering a measurement signal of the stimulus 197 and is the preferred holographic pattern and thus linked to a given stimulus. Therefore, after the difference between the first and second image capture with the initial holographic pattern driven onto display 110 is calculated, the initial holographic pattern may be iterated to determine if a second holographic pattern driven on display 110 generates an even greater difference (measured by amplitude and/or phase) between a first and second image capture. Signal 123 is altered by driving a different holographic pattern on display 110, via for example simulated annealing, to maximize the difference between the first image capture and the second image capture. The holographic pattern may be iterated many times while seeking the largest change between the first and second image capture. This technique is used to create a dictionary (i.e. lookup table) of holographic patterns (corresponding to input signal 123) to map to focus the light sequentially to each and every stimulus 197 and scanning of various stimuli.

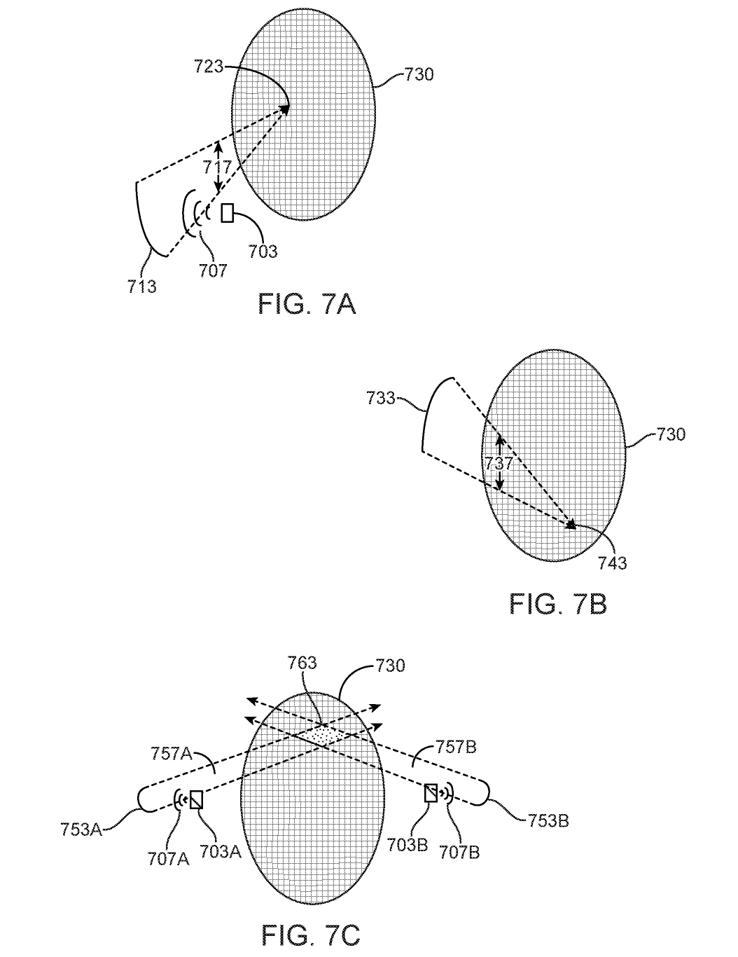

FIGS. 7A-7C illustrate example configurations of ultrasonic emitter 115. In FIG. 7A, directional ultrasonic emitter 115 includes a point source ultrasonic emitter 703 and an electronically controlled membrane 713. Point source ultrasonic emitter 703 is directed toward an electronically controlled membrane 713 that changes shape according to electronic input from processing logic 101. Changing the lensing shape of the membrane 713 electronically causes the ultrasonic signal 707 to be reflected and focused as beam 717 to the area of interest 723 in a diffuse medium 730. In some embodiments, the membrane includes polyvinylidene fluoride (PVDF).

In the embodiment illustrated in FIG. 7B, directional ultrasonic emitter 115 includes a piezo-membrane 733 that emits focused ultrasonic beam 737 to area of interest 747. Piezo-membrane 733 is a membrane having an array of regions and different electronic signals that drive the different regions. By selectively activating the different regions of the piezo-membrane 733, ultrasonic beam 737 can be focused on different points of interest 747 in diffuse medium 730. Piezo-membrane 733 may include polyvinylidene fluoride (PVDF).

FIG. 7C illustrates an additional embodiment of directional ultrasonic emitter 115. In FIG. 7C, the directional ultrasonic emitter includes two ultrasonic emitters. The first ultrasonic emitter includes point source 703A and moveable lens 753A. The second ultrasonic emitter includes point source 703B and moveable lens 753B. The first and second ultrasonic emitters are spaced apart from each other. The first ultrasonic emitter steers moveable lens 753A to direct an ultrasonic beam 757A with little divergence to the point of interest 763. Beam 757A propagates through point of interest 763, but is not focused on point of interest 763. The second ultrasonic emitter steers moveable lens 753B to direct an ultrasonic beam 757B with little divergence to the point of interest 763. Beam 757B propagates through point of interest 763, but is not focused on point of interest 763. The intersection of beams 757A and 757B create a local compression zone at point of interest 763.

The directional ultrasonic emitter 115 can be optionally used with IR display 113 to create a scanning look up table that links voxels in three-dimensional diffuse medium 130 with holographic patterns that can be driven onto IR display 113. This can also be achieved without the use of the directional ultrasonic emitter 115 as a beacon but instead through the use of other stimuli as described in [0033] and [0034].

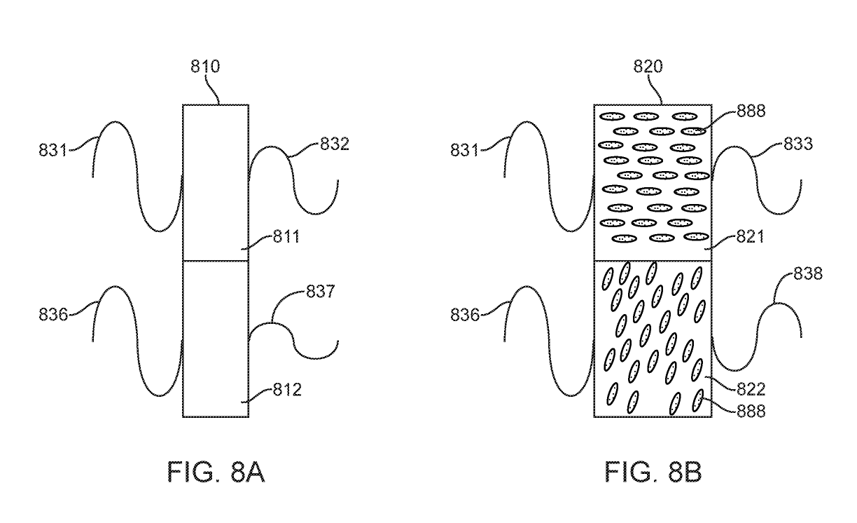

FIGS. 8A and B illustrates an example side view of example pixels of a display pixel array that can be used as display pixel array 113. Display pixel array 113 may include amplitude modulation architecture 810 or a phase modulator architecture 820 or both. Amplitude modulator 810 functions similarly to conventional LCDs (modulating amplitude by adjusting voltage across liquid crystal pixel to rotate polarized light) except that the polarizers found in conventional LCDs are replaced with polarizers configured to polarize IR wavefront 107 and the liquid crystals are tuned to modulate infrared light. Amplitude modulator 810 can be solely used to modulate the amplitude of the signal and create the holographic wavefront 123 by creating diffractive slits for example. Phase modulator system 820 enables higher light throughput than modulator 810 by creating the same holographic wavefront 123 with better efficacy. Example light rays 831 and 836 may be part of infrared wavefront 107. Light ray 831 encounters pixel 811 and the amplitude of ray 831 is modulated to the amplitude of light ray 832. Similarly, light ray 836 encounters pixel 812 and the amplitude of ray 836 is modulated to the amplitude of light ray 837.

Alternatively, light ray 831 encounters pixel 821 and the phase of light ray 831 is modulated by pixel 821. Pixel 821 includes liquid crystals 888 disposed between two electrodes (e.g. indium tin oxide). A voltage across the electrodes changes the alignment of the liquid crystals 888 and the refractive index of the pixel 821 is changed according to the alignment of the liquid crystals 888. Thus, modulating the refractive index shortens or lengthens the optical path through the pixel 821, which changes the phase of the light rays 833 that exits pixel 821. In some embodiments, pixel 821 is configured so that applying a minimum voltage (e.g. 0V) across the electrodes of pixel 821 causes light ray 831 to not be phase shifted while applying a maximum voltage across the electrodes causes light ray 831 to be phase shifted 359°. Thus, applying voltages across the electrodes between the minimum and maximum voltages give full grey-scale control of phase shifting light ray 831 between 0° (zero radians) and 359° (almost 2π radians). To achieve this range, the optical path length of light ray 831 from the minimum to the maximum refractive index will need to differ by almost one full wavelength of the light (to achieve a phase shift of 359). In some embodiments, the optical path length difference from the minimum refractive index is 850 nm to correspond with an 850 nm laser diode that generates infrared wavefront 107. To accommodate the thickness required to change the optical path length by almost a full wavelength, the thickness of phase modulator stage 820 may be thicker than a conventional LCD.

The illustrated embodiment of FIG. 8A shows that different modulation controls (e.g. voltages across the liquid crystal) are being applied to pixels 811 and 812 since the amplitude of light ray 837 exiting pixel 812 is smaller than the amplitude of light ray 832 exiting pixel 811. The illustrated embodiment of FIG. 8B shows that the phase of light ray 838 is adjusted 7t compared to the phase of light ray 833. As explained above, the phase of the light rays that propagate through pixels of phase modulator stage 820 can be modulated by adjusting the alignment of liquid crystals 888 to change the refractive index of the pixels in FIG. 8B. As illustrated, the alignment of the liquid crystals 888 in pixels 821 and 822 is different.

To generate a composite image of diffuse medium 130, multiple voxels of diffuse medium 130 can be imaged by imaging system 100 of FIG. 1. Prior to imaging each voxel, a focusing procedure may be performed to determine a suitable holographic pattern to image that voxel. In FIG. 1, three-dimensional diffusing medium 130 has an x dimension, a y dimension, and a z dimension (in to the page). The focusing procedure may start at a voxel having a coordinate of 1, 1, 1 and finish at a voxel having a coordinate of q, r, s, where q, r, and s are the number of voxels in each dimension x, y, and, z, respectively. The dimension of each voxel can be any dimension. Each voxel may have a first linear dimension, a second linear dimension, and a third linear dimension. The first linear dimension may be less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The first linear dimension may be within a range defined by any two of the preceding values. The second linear dimension may be less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The second linear dimension may be within a range defined by any two of the preceding values. The third linear dimension may be less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The third linear dimension may be within a range defined by any two of the preceding values. Smaller voxels are possible. Larger voxels are possible.

In one example focusing procedure, display 110 generates a first probing infrared holographic imaging signal 123 by driving a first probing holographic pattern onto display 110. Imaging module 160 captures exit signal 143 in a first calibration infrared image. At a different time, directional ultrasonic emitter 115 is focused on a first voxel (e.g. 1, 1, 1) and imaging module 160 captures exit signal 143 again in a second calibration infrared image. The phase and/or amplitude difference between the first calibration infrared image and the second calibration infrared image is determined. As described above, the phase of the light from exit signal 143 may be determined by analyzing the interference patterns that are recorded in difference pixel groups of the calibration images. The amplitude of exit signals 143 can be determined simply from the image charge readings of each pixel. The determination of the phase and/or amplitude difference may be made by processing logic 101 and written to a memory on-board processing logic 101 or an auxiliary memory coupled to processing logic 101 (not illustrated). A difference value is then linked to the first probing holographic pattern.

Display 110 generates a plurality of probing infrared holographic imaging signals 123 (by driving different probing holographic patterns onto display 110) and records the amplitude and/or phase difference of exit signal 143 for each probing infrared holographic imaging signal between when the directional ultrasonic emitter 115 is and is not focused on the voxel of interest. In one example, fifty probing infrared holographic imaging signals are generated by fifty different probing holographic patterns being driven onto display 110. The fifty different holographic patterns may be random holographic patterns or may be fifty pre-determined holographic patterns that generate beam shapes that make good searching beams that would be well distributed throughout the diffuse medium. After the amplitude and/or phase difference for each probing infrared holographic imaging signal is recorded, a probing holographic pattern that yielded the largest amplitude and/or phase difference in exit signal 143 is selected. A new fifty probing infrared holography imaging signals are generated based on the selection and iteratively an optimum holographic imaging signal for a certain voxel is determined. As discussed above, focusing an ultrasonic signal on a voxel creates a local compression zone that alters the phase of infrared light propagating through the local compression zone. Altering the phase at the voxel will impact the phase of infrared light propagating through the voxel. Changing the phase at the voxel can also impact the amplitude of infrared light received by imaging module 160 since altering the phase at voxel 133 may cause infrared light to scatter differently. Thus, the selected probing holographic pattern that generated the largest phase difference (and/or amplitude difference) in exit signal 143 can be assumed to have best directed light to image pixel array 170 via the voxel of interest.

Infrared holographic imaging signal 123 can be shaped to “focus” on imaging module 160 even though it encounters a diffuse medium 130. The focusing procedure described in this disclosure is the process of shaping the holographic imaging signal displayed by display 110 to focus the holographic imaging signal on imaging module 160 while also propagating through a specific voxel (e.g. voxel 133).

Determining the selected probing holographic pattern that generates the largest phase difference in exit signal 143 may be a first stage of the focusing procedure for a given voxel. In some embodiments, a second stage of the focusing procedure includes a Simulated Annealing (SA) algorithm that includes iterating on the selected probing holographic pattern to generate a fine-tuned holographic pattern that generates an even greater phase change in exit signal 143 (the larger phase change indicating even more infrared light being focused on imaging module 160 via voxel 133) than the selected probing holographic pattern. In another embodiment, the second stage focusing procedure (using Simulated Annealing) can be used standalone without the first stage.

The selected probing holographic pattern for the voxel, or group of voxels is linked to the voxel or group of voxels if only the first stage of the focusing procedure is implemented. The fine-tuned holographic pattern is linked to the voxel or group of voxels if the second stage of the focusing procedure is implemented. The linked holographic pattern may be stored in a lookup table. The focusing procedure is repeated for each voxel of interest in diffusing medium 130. Hence, each voxel is linked to a preferred holographic pattern for that voxel that generates an infrared holographic imaging signal that is focused on the particular voxel and then can be measured as exit signal 143 by imaging module 160. Through an iterative approach, the focusing of the imaging signal 123 to a voxel or group of voxels improves over time.

Processing logic 101 has access to the lookup table, and thus, a preferred holographic pattern is linked to each voxel in diffusing medium 130. Then, to image diffusing medium 130, the preferred holographic pattern for each voxel or group of voxels is driven onto display 110 and the exit signal 143 for that voxel is captured by imaging module 160 as an infrared image. Changes to that infrared image for that voxel indicate a change in the voxel or group of voxels. Imaging system 100 cycles through imaging each voxel or group of voxels until each voxel or group of voxels of interest has been scanned. A three-dimensional composite image can be generated by combining the imaged changes of each individual voxel over time. It is noted that once a lookup table is generated that links each voxel or group of voxels to a preferred holographic pattern, using directional ultrasonic emitter 115 or training stimuli are not required to perform the imaging of diffuse medium 130. Furthermore, imaging module 160 doesn't necessarily need to capture the phase of exit signals 143 since the pixel-by-pixel amplitude data for exit signal 143 may be sufficient for detection of changes in voxels.

The changing exit signals 143 for each voxel can show changes over time. Red blood cells are naturally occurring chromophores in that their optical properties correspond to whether the red blood cell is carrying oxygen or not. An oxygen depleted red blood cell will exhibit different optical properties than an oxygen rich red blood cell. Hence, exit signal 143 for each voxel or group of voxels will change based on the level of oxygen in the red blood cells in that voxel. Oxygen consumption in red blood cells corresponds to active areas of the brain. Thus, the active areas of the brain can be known by analyzing the changes in exit signals 143. The active areas in a brain may indicate an injury, inflammation, a growth, a specific thought, or a specific image that someone is recalling, for example. A large change (over time) of exit signals 143 in neighboring voxels could indicate a tumor growth, for example. Additionally, detecting the active areas in particular voxels can be mapped to different actions or thoughts that a person is having, as shown by Dr. Adam T. Eggebrecht of Washington University's School of Medicine in St. Louis, Mo. Dr. Eggebrecht and his co-authors used a Time of Flight measuring optical wig to map brain function in a May 18, 2014 article in Nature Photonics entitled, “Mapping distributed brain function and networks with diffuse optical tomography.” This system can detect changes in other chromophores like lipid, melanin, water, and fat, but also directly detect changes in neurons themselves. Active neurons change their light scattering properties through change in membrane potential (a fast transition) or cell swelling (a slow transition). Other optical changes in the body, either via chromophore, scattering changes or phase changes can be detected with this system. With the introduction of fluorescent dyes and particles optical excitation of areas that selectively uptake the wavelength shifting material can be detected by looking for the color shift. All of these beacon indicators can be used with the technique described.

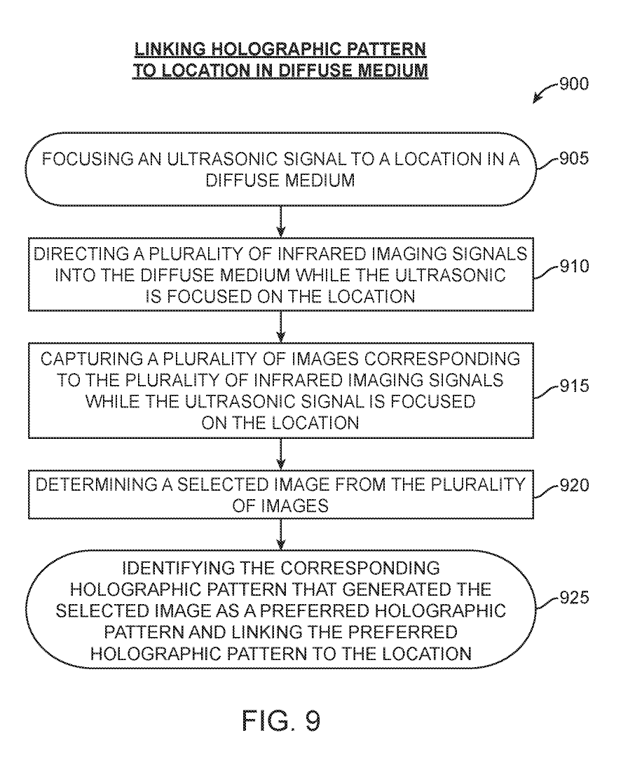

FIG. 9 illustrates an example process 900 of linking a holographic pattern to a location of a diffuse medium that may be performed by imaging system 100 for example, in accordance with some embodiments of the disclosure. The order in which some or all of the process blocks appear in process 900 should not be deemed limiting. Rather, one of ordinary skill in the art having the benefit of the present disclosure will understand that some of the process blocks may be executed in a variety of orders not illustrated, or even in parallel. Some process blocks may be omitted. The instructions for process 900 may be stored in or accessible to processing logic 101 for executing, for example.

In process block 905, an ultrasonic signal (e.g. ultrasonic signal 117) is focused to a location in a diffuse medium (e.g. diffuse medium 130). A plurality of infrared imaging signals is directed into the diffuse medium by driving a corresponding plurality of holographic patterns onto a pixel array (e.g. display 113), in process block 910. The plurality of infrared imaging signals is directed into the diffuse medium while the ultrasonic signal is focused on the location. The plurality of infrared imaging signals (e.g. signal 123) may be directed into the diffuse medium by a holographic display such as display 110.

In process block 915, a plurality of images is captured. The images may be captured by imaging module 160, for example. Each of the images in the plurality captures a corresponding transmission of the plurality of infrared imaging signals directed into the diffuse medium. In other words, a first image in the plurality of images would capture a first transmission of a first infrared imaging signal generated by a first holographic pattern being driven onto the pixel array, a second image in the plurality of images would capture a second transmission of a second infrared imaging signal generated by a second holographic pattern being driven onto the pixel array subsequent to the first holographic pattern being driven onto the pixel array, and so on. As described above, capturing a transmission (e.g. exit signal 143) of an infrared imaging signal while an ultrasonic signal is focused on a voxel allows imaging system 100 to determine which holographic pattern is best suited to image the voxel.

A selected image is determined from the plurality of images by analyzing the plurality of images in process block 920. Each of the plurality of images has a corresponding holographic image pattern. In some embodiments, a phase component of each of the plurality of images is compared to a phase component of a unattenuated image that captured the transmission of an infrared signal generated by the corresponding holographic image pattern when the directional ultrasonic emitter was deactivated. In this way, the phase difference of exit signal 143 can be detected for when the ultrasonic signal is and is not focused on a voxel of a diffuse medium. The analysis of process block 920 may further include determining the selected image by which of the plurality of images had the greatest phase change from its unattenuated image that was captured without the ultrasonic signal 117 being focused on the location.

In process block 925, the holographic pattern that generated the selected image is identified as a preferred holographic pattern and linked to the location. The location and holographic pattern may be stored in a lookup table so that the holographic pattern can be used to image the linked location at a subsequent time.

Process block 925 may be repeated for each voxel of a diffuse medium until each voxel of interest has been linked to a preferred holographic pattern that can be used to generate an infrared holographic imaging signal for imaging the voxel.

Methods that do not use an ultrasonic signal may also be utilized to link a holographic pattern to a location of a diffuse medium. In some embodiments, contrast enhancing injectables or other beacons (e.g. probe) are used to define a certain voxel. Chromophores themselves can also be used as beacons.

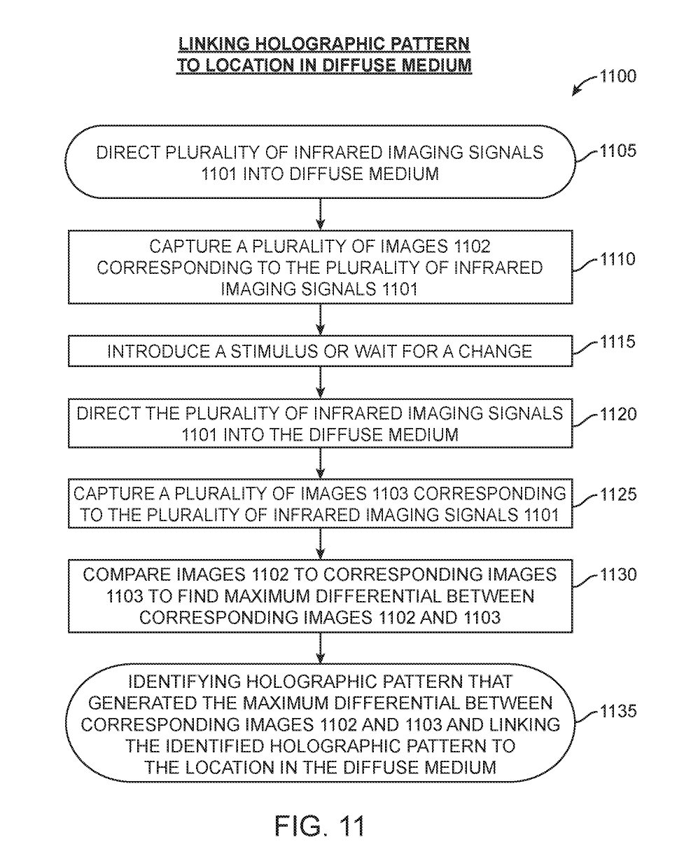

FIG. 11 illustrates an example process 1100 of linking a holographic pattern to a location of a diffuse medium, in accordance with some embodiments of the disclosure. Process 1100 may be performed by system 180 or by systems 100 or 200, where directional ultrasonic emitter 115 is optional since process 1100 does not require directional ultrasonic emitter 115. The order in which some or all of the process blocks appear in process 1100 should not be deemed limiting. Rather, one of ordinary skill in the art having the benefit of the present disclosure will understand that some of the process blocks may be executed in a variety of orders not illustrated, or even in parallel. The instructions for process 1100 may be stored in or accessible to processing logic 101/201 for executing, for example.

A plurality of infrared imaging signals 1101 is directed into the diffuse medium by driving a corresponding plurality of holographic patterns onto a pixel array (e.g. display 113), in process block 1105. The plurality of infrared imaging signals (e.g. signal 123) may be directed into the diffuse medium by a holographic display such as display 110.

In process block 1110, a plurality of images 1102 is captured. The images 1102 may be captured by imaging module 160, for example. Each of the images in the plurality of images 1102 captures a corresponding transmission of the plurality of infrared imaging signals 1101 directed into the diffuse medium in process block 1105. In other words, a first image in the plurality of images 1102 would capture a first transmission of a first infrared imaging signal generated by a first holographic pattern being driven onto the pixel array, a second image in the plurality of images would capture a second transmission of a second infrared imaging signal generated by a second holographic pattern being driven onto the pixel array subsequent to the first holographic pattern being driven onto the pixel array, and so on. As described above, capturing a transmission (e.g. exit signal 143) of an infrared imaging signal while a stimulus is first not present and then present allows imaging system 100 to determine which holographic pattern is best suited to image the group of voxels changed by the stimulus.

In process block 1115 a stimulus is introduced or a period of time is allowed to pass. Where the brain is being imaged, the stimulus (e.g. stimulus 197) may be showing an image to a person, playing music for the person, or requesting that the person think of an idea or an image. At process block 1120, the plurality of infrared imaging signals 1101 are directed into the diffuse medium. In process block 1125, a plurality of images 1103 are captured. Each of the images in the plurality of images 1103 captures a corresponding transmission of the plurality of infrared imaging signals 1101 directed into the diffuse medium in process block 1120 while the stimulus of process block 115 is applied or presented.

In process block 1130, corresponding images from the plurality of images 1102 and the plurality of images 1103 are compared to find the maximum differential between corresponding images. Corresponding images from the plurality of images 1102 and 1103 are images that are captured when the same holographic pattern is driven onto the display. Each of the plurality of images has a corresponding holographic image pattern without stimulus applied in the group of images 1102 and with stimulus applied in the group of images 1103. In some embodiments, a phase component of each image from 1103 is compared to a phase component of a corresponding unattenuated image from 1102 that captured the transmission of an infrared signal generated by the corresponding holographic image pattern when no stimulus was presented. In this way, the phase difference of exit signal 143 for a given voxel can be detected for when a stimulus is and is not present. The analysis finding the maximum differential of process block 1130 may further include determining which of the corresponding images from 1102 and 1103 have the largest phase change.

In process block 1135, the holographic pattern that generated the maximum differential in process block 1130 is identified as a preferred holographic pattern and linked to the location/voxel of interest. The location and holographic pattern may be stored in a lookup table so that the holographic pattern can be used to image the linked location at a subsequent time.

Process block 1130 may be repeated for each stimulus of a diffuse medium until the stimulus of interest has been linked to a preferred holographic pattern that can be used to generate an infrared holographic imaging signal for imaging the voxel.

FIG. 2A illustrates an imaging system 200 that includes an integrated module 290A that includes image pixel array 170, filter 173, IR director 103, IR emitter 105, IR display 113, IR director 253, and IR emitter 155. Imaging system 200 may also include directional ultrasonic emitter 115 and processing logic 201. Imaging system 200 may also include the wireless transceiver described in system 100 as coupled to processing logic 201. In the illustrated embodiment of integrated module 290A, filter 173 is disposed between IR director 103 and image pixel array 170. IR director 103 is disposed between IR display 113 and filter 173. IR display 113 is disposed between IR director 253 and IR director 103.

Imaging system 200 has similarities to imaging system 100. IR emitter 105 is activated by output X3 of processing logic 201. IR director 103 receives the infrared light from IR emitter 105 and directs the infrared light to IR display 113 as IR wavefront 107 to illuminate IR display 113. A holographic pattern is driven onto IR display 113 to generate an infrared holographic imaging signal 223, which is directed to voxel 133. Signal 223 propagates through voxel 133 and is incident on integrated module 290B as exit signal 273. Integrated module 290B may be the same as integrated module 290A, in FIG. 2. Integrated module 290B may comprise some of the components of integrated module 290A. Integrated module 290B may include an image pixel array 170 that images exit signal 273 through IR display 113. The amplitude and phase modulations (if any) of the pixels of IR display 113 within integrated module 290B can be subtracted from the image capture of exit signal 273 by processing logic 201 to determine the actual image of exit signal 273. For example, if a display pixel of IR display 113 within integrated module 290 was driven to cut the amplitude of incident infrared light in half, the image signal generated by exit signal 273 on the image pixel directly behind the display pixel would be multiplied by two to recover the original amplitude of exit signal 273. In some embodiments, the pixel dimensions of display 113 and image pixel array 170 are the same. The phase of the light from the exit signal 273 can be recovered similarly by accounting for the phase shift (if any) that is driven onto display pixels of display 113.

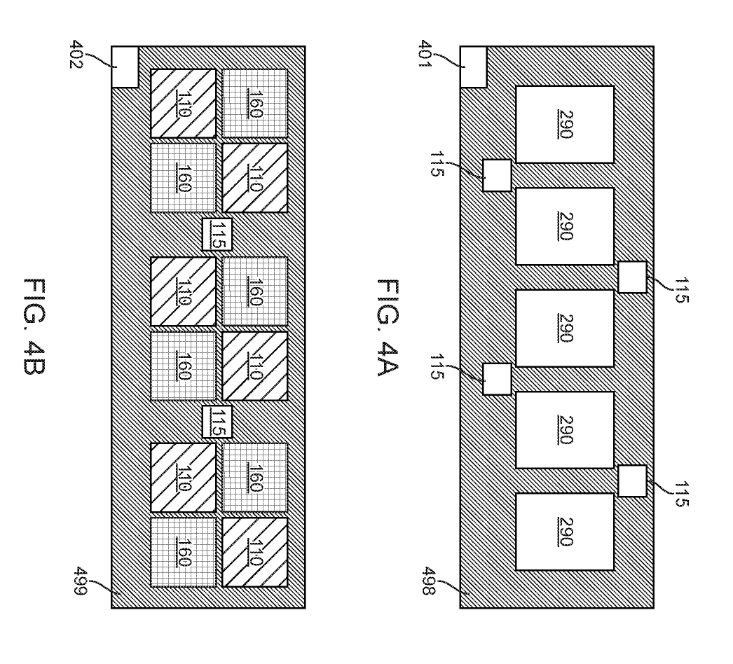

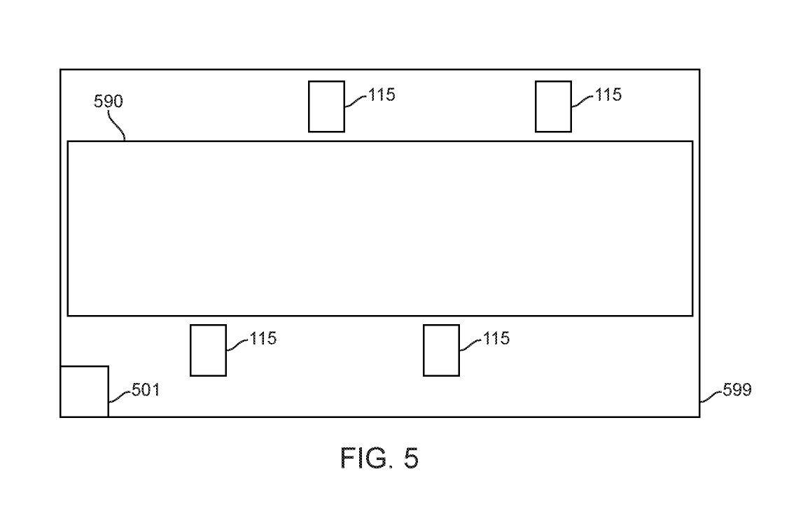

Holographic patterns for driving onto IR display 113 to image different voxels of diffuse medium 130 may be determined similarly to process 900 or 1100. Integrating IR display 113 with the image pixel array 170 in integrated module 290 is potentially advantageous for packaging and form factor reasons, as will be described in connection with FIGS. 4A and 5. Integrated module 290 may also be advantageous because integrated module 290B could both image exit signal 273 and generate its own infrared holographic imaging signal 293 to be sent back to integrated module 290A (as exit signal 243) via voxel 133. In some embodiments, integrated module 290B images exit signal 273 and determines the phase and amplitude of the exit signal 273 using the techniques described above. Since the optical path between integrated modules 290A and 290B is reversible, integrated module 290B may calculate the conjugate of the imaged exit signal 273 and drive the conjugate holographic pattern onto its own IR display 113 to generate its own infrared holographic imaging signal 293 that is directed back to IR display 113 via voxel 133 as exit signal 243. As the infrared holographic imaging signal 293 propagates through diffuse medium 130 in the opposite direction, the phase and amplitude will then match the initial holographic pattern driven onto IR display 113 of integrated module 290A. The image pixel array 170 of integrated module 290A can measure the amplitude and phase of exit signal 243 and compare it to the holographic pattern that was originally driven onto IR display 113. Differences between exit signal 243 and the holographic pattern driven onto IR display 113 can then be detected and analyzed for changes within voxel 133.

Although there will be some movement of the body when system 100 or 200 is imaging, valuable imaging signals can still be obtained since the movement is relatively slow compared to the imaging speed. Movement of the tissue being imaged may come from movement of the head or from a heart pumping blood, or a vein expanding and contracting due to different blood flow, for example. To aid in the imaging, the Memory Effect principles described in Issac Freund's 1988 article entitled, “Memory Effects in Propagation of Optical Waves through Disordered Media” (Rev. Lett 61, 2328, Published Nov. 14, 1988) can be employed. Additionally, big data analytics may be employed to organize the images of voxels into a composite image.

Imaging system 200 may comprise an attainable imaging resolution of less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. Imaging system 200 may have an attainable imaging resolution that is within a range defined by any two of the preceding values.

Imaging system 200 may be configured to operate in a forward scattering mode. In the forward scattering mode, light may be detected following one or more scattering events that give rise to an overall transmission of light through the sample being imaged.

Imaging may be conducted in a back scattering mode. In the back scattering mode, light may be detected following one or more scattering events that give rise to an overall reflection of light from the sample being imaged.

FIG. 2B illustrates an imaging system 201 configured to operate in a back scattering mode. Imaging system 201 may comprise any of the elements of imaging system 200, as described herein. Imaging system 201 may lack the integrated module 290B of imaging system 200.

Referring to FIG. 2B, IR emitter 105 is activated by output X3 of processing logic 201. IR director 103 receives the infrared light from IR emitter 105 and directs the infrared light to IR display 113 as IR wavefront 107 to illuminate IR display 113. A holographic pattern is driven onto IR display 113 to generate an infrared holographic imaging signal 223, which is directed to voxel 133. Signal 223 is backscattered from voxel 133 and is incident on integrated module 290A as exit signal 274. Integrated module 290A may include an image pixel array 170 that images exit signal 274 through IR display 113. The amplitude and phase modulations (if any) of the pixels of IR display 113 within integrated module 290A can be subtracted from the image capture of exit signal 274 by processing logic 201 to determine the actual image of exit signal 274. For example, if a display pixel of IR display 113 within integrated module 290A was driven to cut the amplitude of incident infrared light in half, the image signal generated by exit signal 274 on the image pixel directly behind the display pixel would be multiplied by two to recover the original amplitude of exit signal 274. In some embodiments, the pixel dimensions of display 113 and image pixel array 170 are the same. The phase of the light from the exit signal 274 can be recovered similarly by accounting for the phase shift (if any) that is driven onto display pixels of display 113.

Although reference is made to a backscatter mode, one of ordinary skill in the art will recognize that many variations are possible in accordance with the present disclosure. For example, the display 110 and imaging module 160 can be positioned and oriented in many ways with respect to each other, for example at oblique angles in order to capture front scattered or back scattered light.

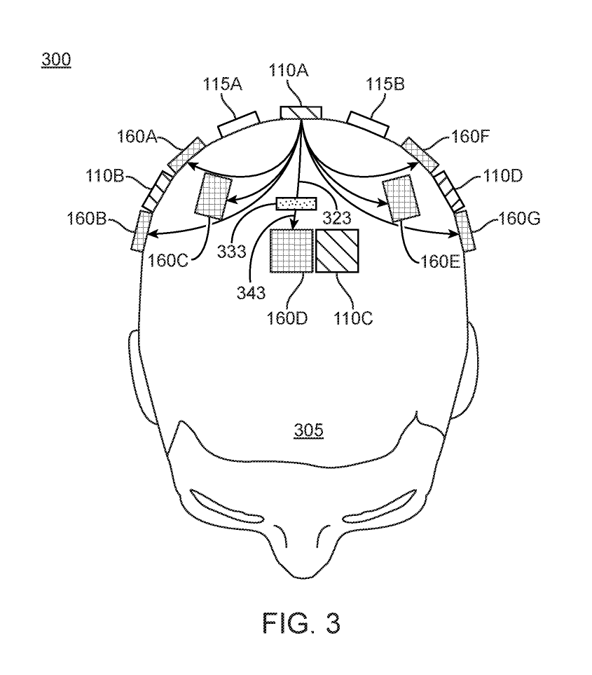

FIG. 3 illustrates an example placement of components of an imaging system 300 in relationship to a human head, in accordance with embodiments of the disclosure. FIG. 3 is a top-down view of a human head 305. Imaging system 300 includes display 110A-110D, imaging modules 160A-160F, and directional ultrasonic emitters 115A and 115B. Components 110A-110D and 160A-160F may all be replaced with module(s) 290 which can function as both display 110 and imaging module 160. Displays 110A-110D and imaging modules 160A-F are shown in FIG. 3 although more or less displays and imaging modules may be used in a system. The displays 110A, 110B, 110C, or 110D as described herein may also be referred to as modulation modules. FIG. 3 shows that display 110A may generate multiple holographic infrared imaging signals 323 that are directed to image different voxels 333 of the brain while the exit signals 343 are imaged by different imaging modules 160. FIG. 3 illustrates that display 110A sends an infrared holographic imaging signal to each of imaging modules 160A-G. The imaging modules 160A, 160B, 160C, 160D, 160E, 160F, or 160G may as described herein also be referred to as detector modules. Not all the voxels, infrared holographic imaging signals, and exit signals are illustrated and referenced in FIG. 3 as to not obscure the description of the system. The other displays 110B-110D may also send infrared holographic imaging signals (not illustrated) to each of imaging modules 160A-F. Scientific literature suggests that the penetration depth of infrared light into tissue is around 10 cm so multiple holographic displays 110 and imaging module 160 may be needed to image the entire brain or other tissue. It is understood that multiple integrated modules 290 could also be strategically placed around head 305 to image head 305.

The arrows drawn from display module 110A to imaging modules 160A, 160B, 160C, 160D, 160E, 160F, and 160G show a simplified and generalized movement of light from the modulation module to the detection modules. A person having skill in the art will recognize that the actual movement of light through a turbid medium such as the brain comprises a complex series of scattering events. At each scattering event, most of the light incident upon a scattered will be scattered in a generally forward direction (aligned with the arrows). Some light will be scattered at angles to the forward direction. Some light will be backscattered. The imaging modules 160A, 160B, 160C, 160D, 160E, 160F, and 160G may be arranged to have a banana-like shape as depicted in FIG. 3. The banana-like shape may be selected to capture light scattered at many different angles. The placement of the detection modules may depend on the desired depth of imaging, and the system can be adapted to accommodate many placement locations and orientations with the holographic patterns as described herein.

FIGS. 4A and 4B illustrate example form-factor implementations of a wearable imaging system, in accordance with an embodiment of the disclosure. FIG. 4A includes a wearable imaging system 498 that includes four optional directional ultrasonic emitters 115, five integrated modules 290, and processing logic 401. Processing logic 401 may be implemented similarly to processing logic 101. Wearable imaging system 498 may include a fabric that has the illustrated components embedded into the fabric. The fabric may be in the form of a wrap that can be wrapped around an abdomen or other body area to facilitate imaging those body areas. The fabric may have velcro or other linking mechanism on edges to assist in maintaining a wrapping around a body area.

FIG. 4B includes a wearable imaging system 499 that includes two optional directional ultrasonic emitters, six displays 110, six imaging modules 160, and processing logic 402. Processing logic 402 may be implemented similarly to processing logic 101. Wearable imaging system 499 may include a fabric that has the illustrated components embedded into the fabric. The fabric may be in the form of a wrap that can be wrapped around an abdomen or other body area to facilitate imaging those body areas. The fabric may have velcro or other linking mechanism on edges to assist in maintaining a wrapping around a body area.

FIG. 5 illustrates an example configuration of a flexible wearable imaging system 599, in accordance with an embodiment of the disclosure. Imaging system 599 includes four optional directional ultrasonic emitters, one monolithic integrated module 290, and processing logic 501. Processing logic 501 may be implemented similarly to processing logic 101. Wearable imaging system 599 may include a fabric that has the illustrated components embedded into the fabric. The fabric may be in the form of a wrap that can be wrapped around an abdomen or other body area to facilitate imaging those body areas. The fabric may have velcro or other linking mechanism on edges to assist in maintain a wrapping around a body area. Imaging system 599 is similar to imaging system 498 in that it includes integrated modules. Integrated module 590 is similar to integrated module 290 except that integrated module 590 is built with flexible components so that integrated module 590 can be monolithic and therefore provide a large-area holographic display and large-area imaging module in one component that would be potentially less expensive to manufacture. Flexible LCD technology is used for the holographic display for example. It is understood that batteries, power regulators, and other required components of imaging systems 498, 499, and 599 are not illustrated so as not to obscure the Figures of the disclosure.

Though referred to as an imaging system through the disclosure, systems 100, 199, 200, or 201 may alternatively serve to focus light in a translucent material at a location within the translucent material. In such cases, the systems 100, 199, 200, or 201 may be also referred to as a focusing apparatus. A focusing apparatus may offer the ability to optically manipulate turbid media in cases in which imaging is not required. For instance, system 100, 199, 200, or 201 may be used to focus light to locations within a translucent photoactive liquid, such as may be used in 3D printing applications, as described herein. In this and other applications, the imaging capabilities of systems 100, 199, 200, or 201 may not be helpful. One having skill in the art will readily perceive which applications disclosed herein may require an imaging capability and which may not. In some cases, the focusing apparatus may comprise one or more components of an imaging system configured to generate an image of structures within a translucent material.

The focusing apparatus may be similar to systems 100, 199, 200, or 201. The focusing apparatus may comprise a first light source. The first light source may direct first light along an optical path. The first light source may comprise a first light director. The first light director may comprise a light guide. The first light director may comprise a light plate. The first light director may comprise a slim prism. The first light director may comprise a diffractive grating. The first light director may comprise a series of cascaded beam splitters. The first light director may comprise a set of tandem glued beamsplitters of various reflectances and transmittances cascaded together to create a tiled beam perpendicular to the array of prisms. The first light director may comprise a pupil expander. The first light director may comprise a lenslet array.

The focusing apparatus may comprise a transmissive spatial light modulator. The transmissive spatial light modulator may be coupled to the first light source. The transmissive spatial light modulator may transmit modulated light to the location within the material. The transmissive spatial light modulator may comprise a first plurality of modulation pixels. The first plurality of modulation pixels may modulate an amplitude or a phase of light transmitted to the location.

The focusing apparatus may comprise a second light source. The second light source may direct second light along an optical path of light received from the location. The second light may interfere with light received from the location. The second light source may comprise a second light director. The second light direction may comprise a light guide. The second light direction may comprise a light plate. The second light direction may comprise a slim prism. The second light direction may comprise a diffractive grating. The second light direction may comprise a series of cascaded beam splitters. The second light direction may comprise a set of tandem glued beamsplitters of various reflectances and transmittances cascaded together to create a tiled beam perpendicular to the array of prisms. The second light direction may comprise a pupil expander. The second light direction may comprise a lenslet array.

The focusing apparatus may comprise a detector. The detector may comprising a plurality of detector pixels. The detector may be arranged with the second light source to receive light from the sample and the second light source. The detector may be a silicon detector. The detector may be a non-silicon detector configured to measure black body radiation emitted from an object having a temperature within a range from about 100 K to about 400 K.

The focusing apparatus may comprise a processor. The processor may be coupled to the detector and the spatial light modulator. The processor may be configured with instructions to adjust the amplitude of phase of the plurality of modulation pixels to focus the light at the location. The processor may be configured with instruction to provide a phase conjugate on the transmissive spatial light modulator with the plurality of modulation pixels in order to focus the light at a location or a plurality of locations.

The processor may be configured to form an image of a material with a resolution of less than 1 micron, less than 2 microns, less than 5 microns, less than 10 micron, less than 20 microns, less than 50 microns, less than 100 micron, less than 200 microns, less than 500 microns, less than 1,000 micron, less than 2,000 microns, less than 5,000 microns, or less than 10,000 microns. The processor may be configured to form an image of a material with a resolution that is within a range defined by any two of the preceding values.

The focusing apparatus may be configured such that an optical axis of the spatial light modulator and an optical axis of the second light source arranged at oblique angles to each other, for example with reference to FIG. 3. The optical axes may be coupled to an object at a plurality of spaced apart locations to receive scattered light from an object.

The modulator module and the detector module can be arranged in many ways. For example, the modulator module and the detector module may be located at a plurality of spaced apart locations. The focusing apparatus may comprise a plurality of modulator modules and a plurality of detector modules. The plurality of detector modules may be coupled to an object at a plurality of spaced apart locations. The plurality of detector modules may be coupled to an object at least 2, at least 3, at least 4, or at least 5 locations, for example. The spaced apart locations at which the modules are coupled to the object may correspond volumetric locations within an object for which light is to be focused or imaged The plurality of modulator modules and the plurality of detector modules may be coupled to the processor or each other in a networked configuration, and a plurality of optical fibers can extend between the plurality of modules. The optical fibers can be configured to transmit digital data. Alternatively or in combination, the optical fibers can be configured to transmit coherent light between modules so as to generate interference patterns on the detectors as described herein.

The focusing apparatus may be configured to move in relation to a location. The focusing apparatus may be coupled to a known actuator and configured to move translationally or rotationally. The focusing apparatus may be configured to move at least about 1 cm, at least about 2 cm, at least about 5 cm, 10 cm, at least about 20 cm, at least about 50 cm, or at least about 100 cm. The focusing apparatus may be configured to move within a translational range defined by any two of the preceding values. The focusing apparatus may be configured to rotate at least 1 degree, at least 2 degrees, at least 5 degrees, at least 10 degrees, at least 20 degrees, at least 50 degrees, at least 100 degrees, or at least 200 degrees. The focusing apparatus may be configured to rotate within a range defined by any two of the preceding values. Movement of the focusing apparatus over a distance may enable the focusing apparatus to image a volume of a material that is larger than a field of view of the detector. The distance may correspond to a distance of a patient, such as a height of the patient.

The focusing apparatus may be arranged such that the first light source, the transmissive spatial light modulator, the second light source, and the detector are arranged to increase an amount of light transmitted to the detector from the spatial light modulator in response to scattering of light within a translucent material, for example with reference to FIG. 3. In accordance with some embodiments, the scattering of the object such as a head provides light to the detectors, and in some instances removal of the scattering object would result in a substantially decreased optical signal to the detector.

The focusing apparatus may be arranged such that the first light source, the transmissive spatial light modulator, the second light source, and the detector are arranged in sequence. The location at which light is focused may be disposed between the transmissive spatial light modulator and the second light source, for example with reference to FIG. 1. The location at which light is focused may be disposed on an opposite side of the second light source from the spatial light modulator in order to receive backscattered light from a sample, for example with reference to FIG. 2B.

The focusing apparatus may be arranged such that the first light source and the transmissive spatial light modulator are arranged in a first sequence oriented to direct light toward the location or plurality of locations along an axis or a plurality of axes extending from the spatial light modulator toward the location or plurality of locations corresponding the plurality of voxels 333. The second light source and the detector may be arranged and oriented in a second sequence away from the axis in order to receive forward scattered light transmitted obliquely from the location and away from the axis, for example with reference to FIG. 3. The forward scattered light transmitted through the material to the detector may correspond to a curved energy profile distribution as shown with the arrows of FIG. 3. The curved energy profile distribution may correspond to a banana-like shape.

The focusing apparatus may be configured such that the transmissive spatial light modulator is separated from the first light source such as the IR director by a distance 112 of no more than about 1 mm, no more than about 2 mm, no more than about 5 mm, no more than about 10 mm, no more than about 20 mm, no more than about 50 mm, or no more than about 100 mm. The transmissive spatial light modulator may be separated from the first light source by a distance that is within a range defined by any two of the preceding values.

The spatial light modulator such as display 110 and the second light source such as IR director 153 may be arranged at oblique angles to each other. This arrangement may increase an amount of light transmitted from the spatial light modulator to the detector in response to scatting of light within a translucent material, for example with reference to FIGS. 1 and 3.

The focusing apparatus may be configured such that the second light source such as director 153 is separated from the detector such as image pixel array 170 by a distance 162 of no more than about 1 mm, no more than about 2 mm, no more than about 5 mm, no more than about 10 mm, no more than about 20 mm, no more than about 50 mm, or no more than about 100 mm. The second light source may be separated from the detector by a distance that is within a range defined by any two of the preceding values. The filter such as IR filter 173 can be located between the light source and the detector. The filter may comprise any suitable filter configured to transmit wavelengths modulated light as described herein, such as a bandpass filter or an interference filter, for example. The filter can be configured to transmit any suitable band of wavelengths, for example within a range from about 5 nm to about 20 nm. The light transmitted through the filter may comprise any wavelength of light as described herein such as ultraviolet, visible and infrared light for example.

The focusing apparatus may be configured such that the detector such as image pixel array 170, the filter such as IR filter 173, the first light source such as IR director 103, the spatial light modulator such as display pixel array 113, and the second light source such as IR director 253 are arranged in sequence to receive backscattered light from the plurality of voxels as described herein such as voxel 133, for example with reference to FIG. 2B. The location of voxel 133 may be disposed on an opposite side of the second light source from the spatial light modulator in order to receive backscattered light from a sample. A holographic pattern comprising a phase conjugate of light received from the sample can be generated as described herein.

The focusing apparatus may be configured such that the first light source, the transmissive spatial light modulator, the second light source and the detector are arranged in sequence. The location may be disposed between the transmissive spatial light modulator and the second light source, for example with reference to FIG. 1.

The spatial light modulator, such as the display pixel array 113 may comprise a number of pixels within a range extending between any two of the following: 10,000 pixels, 20,000 pixels, 50,000 pixels, 100,000 pixels, 200,000 pixels, 500,000 pixels, 1,000,000 pixels, 2,000,000 pixels, 5,000,000 pixels or 10,000,000 pixels.

The detector such as image pixel array 170 may comprise a number of pixels within a range extending between any two of the following: 10,000 pixels, 20,000 pixels, 50,000 pixels, 100,000 pixels, 200,000 pixels, 500,000 pixels, 1,000,000 pixels, 2,000,000 pixels, 5,000,000 pixels, 10,000,000 pixels.

The first light source and the second light source may be coupled to an emitter. For example, the first light source and the second light source can be coupled to a laser with optical fibers and an optical fiber splitter, for example. The first light source may be coupled to a first emitter such as IR emitter 105 and the second light source may be coupled to a second emitter such as IR emitter 155. Although reference is made to IR emitters, the emitter may comprise any suitable light emitter known to one of ordinary skill in the art to generate light having wavelengths as described herein.

The light may comprise a wavelength selected from the group consisting of ultraviolet light, visible light, infrared light, near infrared light, and mid infrared light. The ultraviolet light may comprise a wavelength within a range from about 200 nm to about 380 nm. The visible light may comprise a wavelength within a range from about 380 nm to about 760 nm. The infrared light may comprise a wavelength within a range from about 760 nm to about 6 μm. The near infrared light may comprise a wavelength within a range from about 750 nm to about 2.5 μm. The mid infrared light may comprise a wavelength within a range from about 2.5 μm to about 10 μm. The light may comprise a wavelength within a range from about 700 nm to about 900 nm.

The focusing apparatus may be configured to be held in a hand of a user. The apparatus may comprise a display on a first side. The apparatus my comprise an optically transmissive structure on a second side to optically couple to an object. The processor of the focusing apparatus may comprise instructions to display an image of internal structure of a subject on the display when the second side is optically coupled to skin of the subject.

The display may comprise a light field display. The light field display may be configured to display internal structure of an object in three dimensions. The display may display a three-dimensional image. The display may display an image with full three-dimensional parallax. The display may configured to display structure of the object at a location on the 3D display corresponding to the location of the structure within the object such that a virtual location of the structure is aligned with a physical location of the structure as seen by the user. The display may be configured to display structure of the object at a location on the 3D display corresponding to the location of the structure within the object.

The display may be configured to display the internal structure with a resolution of less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The display may be configured to display the internal structure with a resolution that is within a range defined by any two of the preceding values. The resolution shown on the display may correspond to a resolution of the structure.

The hand held apparatus may comprise a maximum dimension across of no more than about 10 cm, no more than about 15 cm, or no more than about 20 cm and a thickness transverse to the maximum dimension across no more than about 5 cm, no more than about 10 cm, or no more than about 15 cm. The hand held apparatus may weigh no more than about 0.01 kg, no more than about 0.02 kg, no more than about 0.05 kg, no more than about 0.1 kg, no more than about 0.2 kg, no more than about 0.5 kg, no more than about 1 kg, no more than about 2 kg, no more than about 5 kg, or no more than about 10 kg. The hand held apparatus may have a weight that is within a range defined by any two of the preceding values.

The focusing apparatus may be configured to emit light into an object with an energy density of less than 10 mW/cm², less than 20 mW/cm², less than 50 mW/cm², less than 100 mW/cm², less than 200 mW/cm², less than 500 mW/cm², less than 1,000 mW/cm², less than 2,000 mW/cm², less than 5,000 mW/cm², less than 10,000 mW/cm², less than 20,000 mW/cm², less than 50,000 mW/cm², or less than 100,000 mW/cm². The focusing apparatus may be configured to emit light into the object with an energy density that is within a range defined by any two of the preceding values. The focusing apparatus may be configured to transmit light into a translucent material having a scattering coefficient of less than 1 cm⁻¹, less than 2 cm⁻¹, less than 5 cm⁻¹, less than 10 cm⁻¹, less than 20 cm⁻¹, less than 50 cm⁻¹, less than 100 cm⁻¹, less than 200 cm⁻¹, less than 500 cm⁻¹, less than 1,000 cm⁻¹, less than 2,000 cm⁻¹, less than 5,000 cm⁻¹, or less than 10,000 cm⁻¹. The focusing apparatus may be configured to transmit light into a translucent material having a scattering coefficient that is within a range define by any two of the preceding values.

The focusing apparatus may be configured to measure a temperature at the location to which the focusing apparatus directs light.

The focusing apparatus may comprise a support. The support may be configured to support the focusing apparatus on a head of a subject. The support may comprise a hat or band to be worn on the head of a subject. The focusing apparatus may comprise an optically transmissive flexible support structure to support an object to be imaged. The flexible support structure may be configured to receive and conform to the shape of the object on a first side in order to optically coupled to the object to be imaged. The spatial light modulator, the detector, and the light sources may be located on a second side of the support structure. The optically transmissive flexible support structure may comprise a transparent sheet of material.

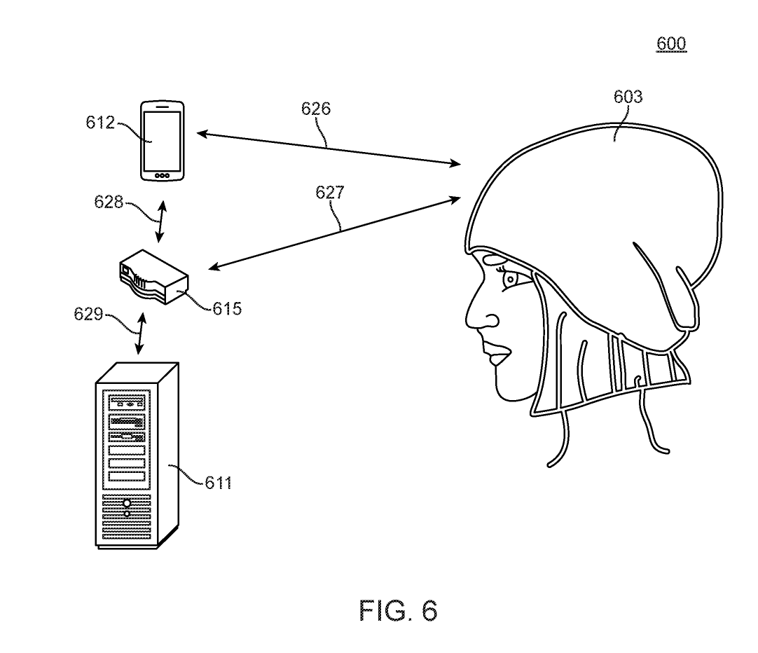

FIG. 6 illustrates a networked system 600 in communication with an example wearable imaging system for being worn on or about a head, in accordance with an embodiment of the disclosure. System 600 includes a ski-cap wearable 603 that is being worn on the head of a user. Systems 100, 200, 300, 498, 499, and/or 599 may be included in wearable 603. Wearable 603 includes wired or wireless network connections to router 615 and/or mobile device 612 (e.g. smartphone or tablet). The communication channel 626 between wearable 603 and mobile device 612 may be BlueTooth™ or WiFi utilizing IEEE 802.11 protocols, for example. The communication channel 627 between wearable 603 and router 615 may use a wired Ethernet connection or WiFi utilizing IEEE 802.11 protocols, for example. Mobile device 612 may also communicate with wearable 603 via communication channels 628 and communication channel 627. Mobile device 612 may give the users some results or alerts about the imaging being performed by wearable 603. Router 615 may also route data from wearable 603 to a computer 611 via communication channel 629. Computer 611 may function as a server, in some embodiments. Computer 611 may give medical professionals access to the imaging of the user's brain by wearable 603, for example.

In some embodiments, processing intensive algorithms are performed by computer or server 611. For example, process 900 or 1100, image processing algorithms, and simulated annealing algorithms described above may be performed by computer 611. In this case, the imaging modules of the systems may capture the images and send the raw data to computer 611 for further processing. Computer 611 may then report the results of the processing back to wearable 603 for local storage. Mobile device 612 may perform similar “off-site” processing for wearable 603.

The techniques described in this disclosure have been described largely in the context of medical imaging. However, the uses of the methods, systems, and devices are not so limited. In one embodiment, imaging small voxels of the brain is used as a way to discern thoughts. Different thoughts and images correspond to different blood usage by neurons (as shown by Dr. Eggebrecht and his co-authors, and others) which can be imaged by the systems, devices, and methods described herein. Discerning (even rudimentary) human thought can be used to assist quadriplegics and others who do not have full functionality of their extremities. Imaging their thoughts could allow for translating their thoughts into a mechanical action (e.g. driving a wheelchair forward or typing words). In one implementation, a user recalls (thinks about) an image of a forward arrow. Imaging system 100, 199, 200, 201 or 280 images the brain and records a voxel pattern that is known to be linked to the forward arrow recalled by the user. When imaging system 100, 199, 200, 201 or 280 images the forward arrow thought pattern, it generates an additional action (e.g. rolling wheel chair forward or typing an “up arrow” on a keyboard).

In one use contemplated by the disclosure, sending infrared light to specific voxels of the brain is used as a therapy. In some cancer treatments, binding agents are ingested or injected, where the binding agents are targeted to selectively bind to tumors. Once the binding agents are bound to the tumor, the described systems could activate the binding agent by selectively exciting the binding agent with infrared light (on a voxel-by-voxel basis), for example. In another use contemplated by the disclosure, the described systems are used in the field of optogenetics—to change the state of neurons with light therapy. Changing the state of neurons with light therapy allows for stimulation of areas of the brain that may otherwise require a physical fiber optic probe being inserted. Light therapy can be used for treatment and research for autism, Schizophrenia, drug abuse, anxiety, and depression, for example. Changing the state of neurons with light therapy may also allow for images or other information to be imparted to the brain, which may be especially useful for patients with memory loss.

The systems and methods described herein may be utilized for a variety of applications. The imaging and focusing systems as described herein may be integrated into one or more systems or devices. The imaging and focusing systems as described herein may be integrated into one or more wearable devices. The wearable devices may allow the ability to image a variety of tissues. For instance, the imaging systems 100, 200, 201 or 300 may be integrated into a headband for imaging one or more areas of a brain. The imaging system may be integrated into a bra for imaging one or more areas of a breast. The imaging system may be integrated into a sock for imaging one or more areas of a foot. The imaging system may be integrated into a glove for imaging one or more areas of a hand. The imaging system may be integrated into a knee or ankle brace for imaging one or more areas of a knee or ankle. The imaging system may be integrated into a wearable device worn on any part of a body for imaging one or more areas of that part of the body.

The wearable devices may be especially useful for monitoring for common injuries in sports. For instance, the wearable device may be utilized to monitor for tendon injuries, ligament injuries, or muscle injuries in the ankles, calf muscles, knees, quadriceps, hamstrings, hips, obliques, ribs, intercostal muscles, sternum, clavicle, pectorals, deltoids, shoulders, latissimus dorsi, biceps, triceps, elbows, forearms, or wrists.

The imaging systems as described herein may image one or more areas of the brain, breast, foot, hand, knee, ankle, or other body part with an imaging resolution of less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The imaging system may image the one or more areas of the brain, breast, foot, hand, knee, ankle, or other body part with an imaging resolution that is within a range defined by any two of the preceding numbers.

Imaging systems as described herein may be integrated into one or more devices that may be utilized to examine a subject during a medical event, such as a visit to a primary care doctor or nurse, medical specialist, urgent care facility, emergency room, hospital visit, ambulance ride, or any other medical event during which rapid internal imaging of a subject may be required or desired. For instance, imaging systems may be integrated into a small area scanner or a movable pad.

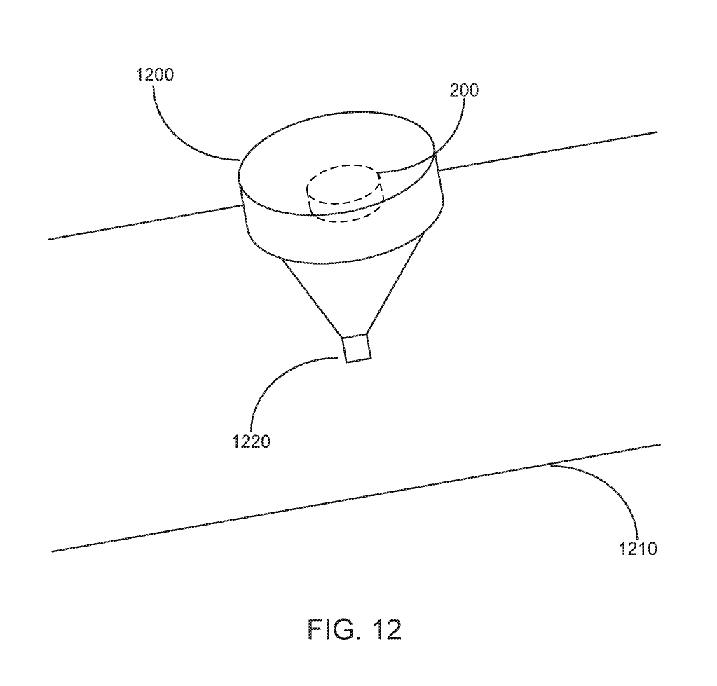

FIG. 12 shows a small area scanner having the form factor of a puck. The small area scanner 1200 may comprise imaging system 200, as depicted in FIGS. 2A and 2B 2, for example, although other imaging and focusing systems as described herein can be used. The small area scanner 1200 may comprise components imaging systems 100, 200 or 300 as described herein, for example. The small area scanner may have the form factor of a cylinder, such as a puck. The small area scanner may have a radius and a height. The small area scanner may have a radius less than 5 cm, less than 10 cm, or less than 20 cm. The small area scanner may have a radius that is within a range defined by any two of the preceding values. The small area scanner may have a height less than 1 cm, less than 2 cm, less than 5 cm, or less than 10 cm. The small area scanner may have a height that is within a range defined by any two of the preceding values. The small area scanner may be placed in contact or at a distance from an exterior surface of tissue 1210 of a body, such as skin. The small area scanner may be placed in contact or at a distance from skin of the abdomen, for instance. The small area scanner may be configured to image an region 1220 located beneath the exterior tissue. For instance, the small area scanner may be configured to image a region located beneath the skin of the abdomen, such as an intestine or other organ. The small area scanner may be configured to image any region located beneath any exterior tissue, such as bones located beneath the skin of an arm, leg, or any other body part, or connective tissues located beneath the skin of a joint. The small area scanner may be configured to image a vein or artery. The small area scanner may allow rapid and facile internal imaging of a variety of body parts. The small area scanner may allow rapid diagnosis, for instance, or a potential stroke or burst appendix.

The small area scanner may image the one or more areas located beneath an exterior tissue with an imaging resolution of less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The small area scanner may image the one or more one or more areas located beneath an exterior tissue with an imaging resolution that is within a range defined by any two of the preceding values.

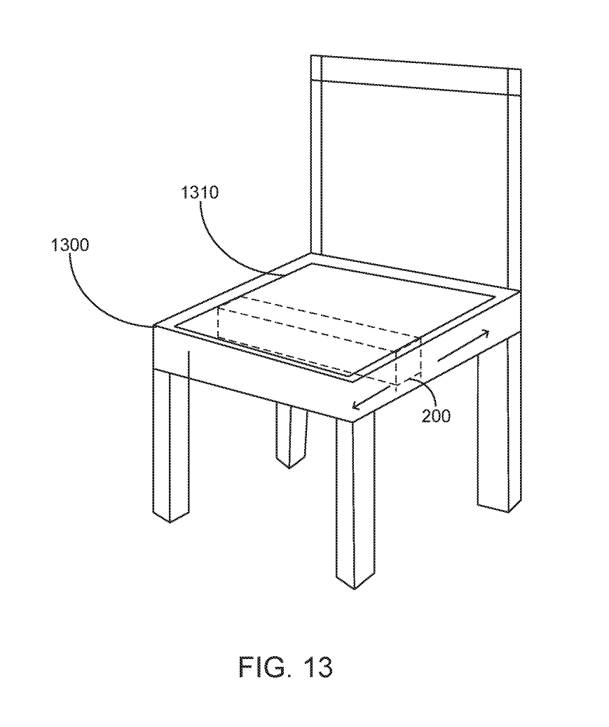

Imaging and focusing systems as described herein may be integrated into one or more pelvic diagnostic devices. For instance, imaging systems 100, 199, 200, 201 or 300 may be integrated into a pad, stool, or chair for imaging of regions located near a pelvis as shown with reference to FIG. 13.

FIG. 13 shows a pelvic diagnostic device having the form factor of a stool or chair or other patient support. The pelvic diagnostic device may have the form factor of an area configured to allow a person to sit atop the pelvic diagnostic device, such as a stool. One or more components of the imaging system can be configured to move while the patient is seated as shown with arrows, for example with translational movement.

The stool may have a width, a depth, and a height. The stool may have a width less than 20 cm, less than 50 cm, or less than 100 cm. The small area scanner may have a width that is within a range defined by any two of the preceding values. The stool may have a depth less than 20 cm, less than 50 cm, or less than 100 cm. The small area scanner may have a depth that is within a range defined by any two of the preceding values. The stool may have a height less than 20 cm, less than 50 cm, or less than 100 cm. The stool may have a height that is within a range defined by any two of the preceding values. The pelvic diagnostic device 1300 may have the form factor of a chair. The pelvic diagnostic device 1300 may have the form of a pad, for example.

The pelvic diagnostic device 1300 may further comprise a flexible membrane 1310. A subject, such as a medical patient or small animal, may sit atop the pelvic diagnostic device, such that the subject makes contact with the flexible membrane. The flexible membrane may conform to an exterior surface of a subject, such as to a subject's skin or clothing. The flexible membrane may provide strong optical coupling between the imaging system and the subject.

The pelvic diagnostic device may be configured to image a region located near a subject's pelvis. For instance, the pelvic diagnostic device may be configured to image a subject's colon, rectum, uterus, ovary, endometrium, urethra, prostate, testicle, vas deferens, or any other reproductive or excretory organ. The pelvic diagnostic device may allow rapid and facile internal imaging of a variety of reproductive or excretory organs to allow, for instance, rapid screening for cancers associated with one or more of these organs.

The pelvic diagnostic device may be configured to allow the imaging system) to move within the bed. This may allow the imaging system to be moved to measure different parts of the body, as appropriate and allow scanning of a total volume greater than a field of view of the imaging system.

The pelvic diagnostic device may image the subject's colon, rectum, uterus, ovary, endometrium, urethra, prostate, testicle, vas deferens, or any other reproductive or excretory organ with an imaging resolution of less than 1 micron, less than 2 microns, less than 5 microns, less than 10 microns, less than 20 microns, less than 50 microns, less than 100 microns, less than 200 microns, less than 500 microns, or less than 1,000 microns, less than 2,000 microns, less than 5,000 microns, or less than 10,000 microns. The pelvic diagnostic device may image the subject's colon, rectum, uterus, ovary, endometrium, urethra, prostate, testicle, vas deferens, or any other reproductive or excretory organ with an imaging resolution that is within a range defined by any two of the preceding values.

Imaging and focusing systems as described herein may be integrated into a full-body diagnostic device.

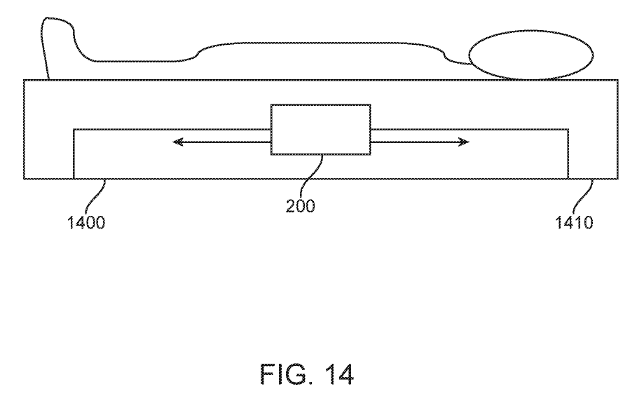

FIG. 14 shows a full-body diagnostic device having the form factor of a patient support such as a bed. The bed may comprise one or more components of the imaging and focusing systems as described herein such as imaging system 200, as depicted in FIG. 14. The bed may be configured to allow a person to lie atop it.

The bed may have a length, a width, and a height. The bed may have a length less than 50 cm, less than 100 cm, or less than 200 cm. The bed may have a length that is within a range defined by any two of the preceding values. The bed may have a width less than 20 cm, less than 50 cm, or less than 100 cm. The bed may have a width that is within a range defined by any two of the preceding values. The bed may have a height less than 20 cm, less than 50 cm, or less than 100 cm. The bed may have a height that is within a range defined by any two of the preceding values.

The bed 1400 may further comprise a flexible membrane 1410. The flexible membrane may comprise a plastic or an elastomeric material, for example. A subject, such as a medical patient, may lie atop the bed, such that the subject makes contact with the flexible membrane. The flexible membrane may conform to an exterior surface of a subject, such as to a subject's skin or clothing. The flexible membrane may provide strong optical coupling between the imaging system and the subject. The flexible membrane may be impermeable to a sanitizer, to allow cleaning of the membrane.

The bed may be configured to allow imaging system 200 (or imaging system 100 or imaging system 300) to move within the bed. This may allow the imaging system to be moved to measure different parts of the body, as needed.

The bed may be a waterbed, for example. Imaging system 200 (or imaging system 100 or 300) may be configured to move within water in the waterbed. The imaging system may be hermetically sealed to be immersed in liquids.

The bed may image any of a subject's body parts with an imaging resolution of less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The bed may image the subject's body part with an imaging resolution that is within a range defined by any two of the preceding numbers.

Imaging systems 100, 199, 200, 201 or 300 may be integrated into a handheld medical diagnostic device.

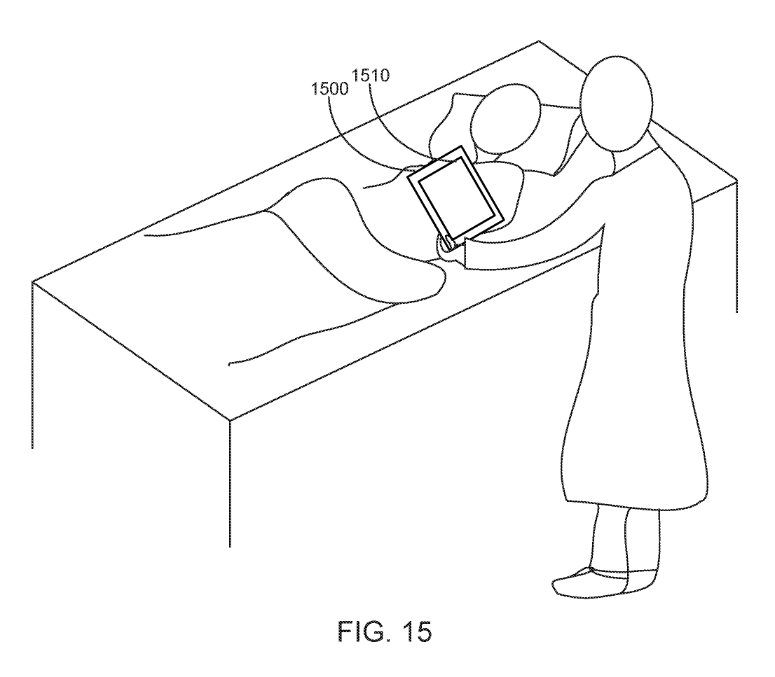

FIG. 15 shows a handheld medical diagnostic device comprising the form factor of tablet 1500. The hand held imaging device may comprise components of any of imaging systems 100, 199, 200, 201 or 300, for example. The tablet may comprise a display device 1510, such as a touchscreen. The display device may display imaging information detected by imaging device 100, 199, 200, or 201 (not shown), which may be integrated into the tablet or attached externally to the tablet. The tablet may comprise one or more location sensors or orientation sensors that detect the position or orientation of the tablet (and thus the imaging device) in the world. The location sensors and orientation sensors may provide information on six degrees of freedom of the tablet, such as the three translational and three rotational degrees of freedom of the tablet. Alternatively, the handheld medical diagnostic device may comprise one or more machine readable icons that may be detected by location sensors or orientation sensors external to the handheld medical diagnostic device. The external location sensors or external orientation sensors may be configured to communicate with the tablet, such as by a wireless communication channel. Output from the location sensors and orientation sensors may allow a processor to align the display of the tablet with the imaging device. In this manner, it may appear that a user of the tablet is looking directly into the patient's body.

The handheld medical diagnostic device may have a three-dimensional display. The three-dimensional display may comprise a virtual reality (VR) or augmented reality (AR) display, such as VR or AR goggles. The three-dimensional display may provide a stereoscopic view into the patient to mimic depth perception.

The handheld medical diagnostic device may allow a user, such as a doctor, nurse, emergency medical technician, field medic, or other medical professional, to view internal structures of a subject in real time. The handheld medical diagnostic device may provide images at a rate of 10 Hz, 20 Hz, 50 Hz, 100 Hz, or 200 Hz. The handheld medical diagnostic device may provide images at a rate within a range that is defined by any two of the preceding values. For instance, the handheld medical diagnostic device may allow a doctor to visualize a ruptured appendix within a patient complaining of pain in the lower abdominal quadrant.

The handheld medical diagnostic device may image any of a subject's body parts with an imaging resolution of less than 1 micron, less than 2 microns, less than 5 microns, less than 10 microns, less than 20 microns, less than 50 microns, less than 100 microns, less than 200 microns, less than 500 microns, less than 1,000 microns, less than 2,000 microns, less than 5,000 microns, or less than 10,000 microns. The handheld medical diagnostic device may image the subject's body part with an imaging resolution that is within a range defined by any two of the preceding values.

The handheld medical diagnostic device may comprise a memory to record imaging data. The handheld medical diagnostic device may be configured to allow a user to review an event recorded in the memory.

The handheld imaging device can be configured in many ways and may comprise a distributed architecture. For example, the puck to show the tissue of the patient in the location of the patient as seen by the user such as a physician. For example the small area scanner 1200 can be combined with a tablet comprising a display. The display may comprise a 3D light field display or goggles, for example. The small area scanner 1200 may comprise position and orientation sensors configured to determine the position and location of the small area scanner in relation to the patient. The display may comprise similar position and orientation sensors. The processor can be configured with instructions to register the 3D virtual image shown on the display with the location of the tissue scanned by the imaging system, such that the user views the tissue in proper registration with the imaged tissue structure, and at the proper depth and location. This configuration can give the user the perception of viewing into the patient through the display device, similarly to the tablet device.

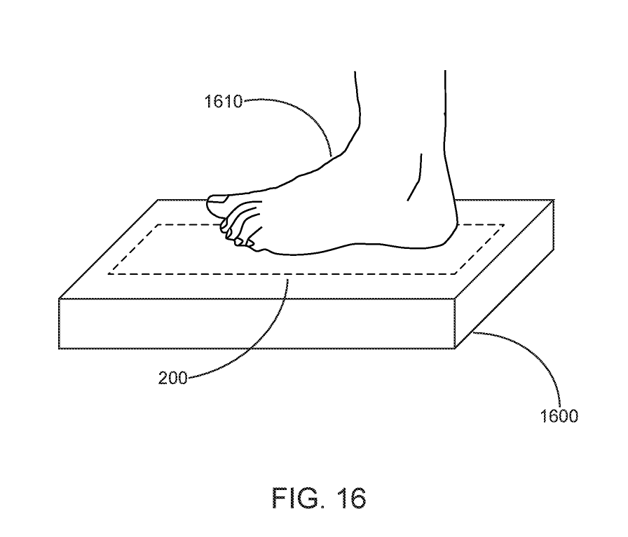

FIG. 16 shows a shoe fitting device 1600 using components of the systems and methods described herein. Components of imaging systems 100, 199, 200, 201 or 300 may be integrated into a shoe fitting device, for example. The shoe fitting device 1600 may comprise imaging system 200, as depicted in FIG. 16, for example. The shoe fitting device may be configured to allow a person to stand on top of it.

The shoe fitting device may image a foot 1610. The foot may be inside a shoe (not shown). The imaging system may image a foot within the shoe. The imaging system may image both the foot and the shoe. Images of the foot and shoe may be analyzed to determine whether the foot fits well within the shoe. Alternatively, the foot can be placed directly on the shoe fitting device 1600.

The systems and methods described herein may have medical applications in areas outside of medical imaging. For instance, the systems and methods may be utilized to stimulate vision within a fully or partially blind subject.

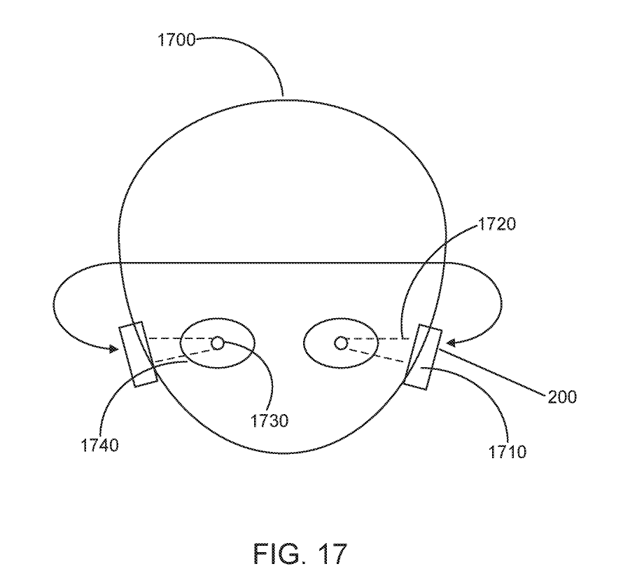

FIG. 17 shows a system for stimulating vision in a subject. Imaging system 200 may be mounted to a location on a subject's head 1700. Imaging system 100 or 201 (not shown) may be mounted to a location of a subject's head. For instance, the imaging system may be mounted to a subject's temple 1710. The imaging system may be mounted to a subject's forehead. The imaging system may be mounted to any other location on the subject's head.

The imaging system may emit light 1720 that travels along a path through the interior of the subject's head. The light may be directed such that scatterers within the subject's head focus the light to the retina 1730 of the subject's eye 1740. The light may have a wavelength that stimulates the retina. In this manner, the light may induce sight in the eye. The light may be directed to bypass the retina and directly stimulate nerves connected to the retina (such as a neural layer above cones of the eye) or to regions of the brain associated with vision, such as the occipital cortex. The light may be emitted as a series of pulses with a duration short enough and an intensity high enough to stimulate the retina, nerves connected to the retina, or regions of the brain associated with vision. The light may be emitted to stimulate vision in one or both eyes.

The systems and methods described herein may be utilized to activate neurons within a user's brain. For instance, the systems and methods may be utilized to activate neurons involved in sight to allow blind people to see, activate neurons involved in hearing to allow deaf people to hear, activate neurons involved in speech synthesis to allow certain mute people to speak, or activate neurons involved in movement to allow disabled people to move. The systems and methods may be utilized to stimulate neurons associated with memory. In this manner, the systems and methods may be used to teach a person without requiring that person to study. The systems and methods may be used to teach a person while that person sleeps.

The systems and methods described herein may be utilized to stimulate internal tissues other than the brain. For instance, the systems and methods may be utilized to stimulate areas within the gut. The systems and methods may be utilized to stimulate one or more sphincters of the gut or smooth muscle of the gut to alleviate gastrointestinal issues. For instance, the systems and methods may be utilized to stimulate the sphincters or smooth muscle to let food into the gut or let food out of the gut.

The systems and methods described herein may be utilized to stimulate neurons to block pain. For instance, the systems and methods may be utilized to stimulate neurons in nerves associated with back pain. In this manner, the systems and methods may be utilized to provide the pain-blocking value of an epidural without requiring a needle.

The systems and methods described herein may be utilized to determine the contents of a user's thoughts. The systems and methods may be utilized to take actions based on the user's thoughts. For instance, the systems and methods may be utilized in brain-machine interfaces. The systems and methods may provide a brain-machine interface to a variety of computerized systems, such as 3D printers. For instance, the systems and methods may determine an architect's thoughts related to an architectural design and direct those thoughts to a 3D printer for rapid prototyping of new architectural concepts.

The systems and methods may be utilized to control peripheral devices. For instance, the systems and methods may be utilized to determine the contents or a surgeon's thoughts related to a surgical procedure and direct a surgical robot based on those thoughts.

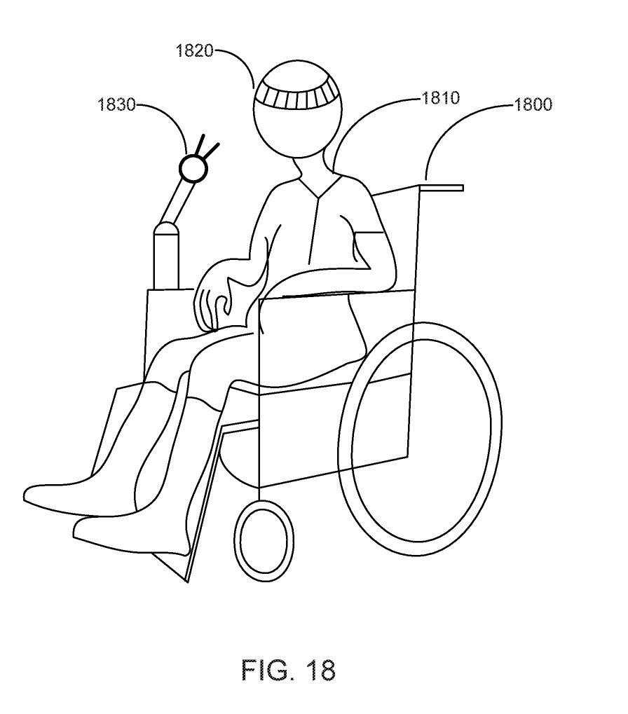

FIG. 18 shows a system for controlling a wheelchair based on a subject's thoughts. The system may comprise a wheelchair 1800. The system may comprise a scooter. The system may comprise an automobile, such as a car. A subject 1810 may sit in the wheelchair. The subject may wear a wearable device 1820 that utilizes the systems and methods described herein to determine the contents of the subject's thoughts. The wearable device may detect thoughts relating to the subject's desire to move the wheelchair. These thoughts may be transmitted to a robotic arm 1830 as is known to one of ordinary skill in the art that moves in response to the subject's thoughts. In this manner, the subject may control movement of the wheelchair or the robotic arm without requiring motion of the subject's body parts. This may allow subjects who are extremely motion-impaired, such as quadriplegic subjects, to control movement of a wheelchair and use a robotic arm.

The systems and methods may aid disabled persons in other manners. For instance, the systems and methods may receive commands from a disabled person's brain to generate speech from a speech synthesizer.

The systems and methods described herein may be utilized to produce direct person-to-person communications links. For instance, two people may have some or all of the contents of their thoughts determined by the systems and methods. These thoughts may then be transmitted between the two people, such as by a wireless communications channel. The systems and methods may allow bi-directional communications between two people without requiring the two people to speak.

The systems and methods described herein may be utilized to determine a subject's thoughts during an interrogation. For instance, the systems and methods may be utilized to determine a criminal suspect's thoughts during questioning. The systems and methods may also be used to determine a subject's state of mind during the interrogation. Information about the subject's state of mind may be utilized to show that the subject was under duress during an interrogation.

The systems and methods described herein may be utilized to determine the contents of a subject's dreams.

The systems and methods described herein may be utilized to inform decisions relating to subjects that appear to be brain dead or otherwise unable to communicate. Subjects that appear to be brain dead may not actually be brain dead. The systems and methods may allow the thoughts of a subject who appears to be brain dead to be determined, if such thoughts are present. For instance, the brain of the subject who appears to be brain dead may be imaged with a functional imaging technique such as a functional magnetic resonance imaging. The functional imaging technique may identify areas in the brain which appear to be active. The systems and methods described herein may then determine the thoughts generated within active areas of the brain. If the person appears to be thinking, this may serve as an indication that the person is not actually brain dead. Such information may inform decisions about how to treat the person.

The systems and methods described herein may be utilized to conduct blood chemistry tests without requiring a blood draw. For instance, the systems and methods may be utilized to measure the concentrations of one or more chemicals within a subject's blood from outside of the body. The systems and methods may be utilized to measure chemical markers of a subject's health, such as a subject's creatinine, cortisol, or cholesterol levels. The systems and methods may be utilized to measure chemical markers in a particular region of the subject's body. The systems and methods may be utilized to measure the levels of intoxicating compounds in a subject's body, such as levels of alcohol or its metabolic products, tethrahydrocannabinol (THC) or its metabolic products, cannabidiol (CBD) or its metabolic products, cocaine or its metabolic products, amphetamines or their metabolic products, opiates or opioids or their metabolic products, or any other drug or its metabolic products.

The systems and methods described herein may be utilized in applications such as drug delivery. The systems and methods may allow targeting of light to specific regions within the body to activate a drug which is inactive prior to exposure to infrared light. The systems and methods may be more selective and more accurate than photodynamic therapy methods which direct infrared light to relatively large regions on which often require markers such as antigens to deliver the drug to particular regions. The systems and methods described herein may be utilized to direct light only to those regions of the body where activation of the drug is desired. For instance, the systems and methods may direct light only to tumorous regions of the body, so that an anti-tumor drug is preferentially activated in those regions. This may have the effect of reducing side effects associated with the anti-tumor drug acting on areas of the body outside of the tumor.

The systems and methods may be utilized for identification purposes. For example, a part of the body scanned can be stored in memory as a unique identifier, such as an organ, a part of an organ, a finger print, an arterial network or structure of the eye such as the retina or iris, for example. Alternatively or in combination, the phase conjugate calculated by the systems and methods may be unique for a particular object or body part of a particular person. The unique identifier may be recorded and stored. The stored unique identifier may then be compared to a new scan of the object at a later point in time and compared to the unique identifier corresponding to structure of the object such as a part of a person, and the scanned structure can be processed similarly to generate a comparison. If the stored and new identifiers are a match, this may indicate that the same object, or body part of the same person is being scanned. Thus, the unique identifier may be utilized for security purposes, such as locking or unlocking doors, electronic devices, or any other device that is intended to be used by a single person. The unique identifier may be utilized for the purpose of ensuring that only the patient for whom a drug is prescribed is able to use the drug, for example. The security applications may utilize any of the wearable devices described herein, and can be used for any application for which a lock is used as will be understood by one of ordinary skill in the art.

Though described above with reference to human health applications, the systems and methods described herein may also be similarly used for imaging within non-human animal subjects. The systems and methods described herein may be used to examine or diagnose injuries and illnesses in a variety of animals, such as non-human primates, horses, livestock such as bovines or sheep, dogs, cats, birds, mice, or any other animal. The systems and methods described herein may be used for animal training purposes. For instance, the systems and methods described herein may be used for biofeedback purposes during training of the animal. The systems and methods described herein may be used to extract information from an animal's sensory perceptions. For instance, the systems and methods described herein may be used to extract information about what an animal with a keen sense of smell (such as a dog or pig) is smelling. This information may be used to detect potentially harmful materials, such as drugs or explosives.

The systems and methods described herein may be utilized for applications in fields outside of the medical fields described above. For instance, the systems and methods may be used for non-destructive testing of infrastructure. The systems and methods may be used to image through concrete (in streets or highways, bridges, buildings, or other structures) to determine whether the concrete or metal rebar within the concrete has been damaged. The systems and methods may be used to image pipelines to determine whether they are damaged and may represent a threat to life, property, or the environment.

The systems and methods described herein may be utilized to image in other building materials, such as stone, brick, wood, sheetrock, thermal insulating, plastic piping, polyvinyl chloride (PVC) piping, fiberglass, or paint.

Imaging in optically dense materials such as concrete may require relatively high optical intensities compared to the medical applications described above. For instance, imaging in concrete may require an optical intensity more than 10 times, more than 100 times, or more than 1,000 times as high as the optical intensities used in the medical applications described herein. Imaging in concrete

The systems and methods described herein may be used for non-destructive characterization of electronics devices.

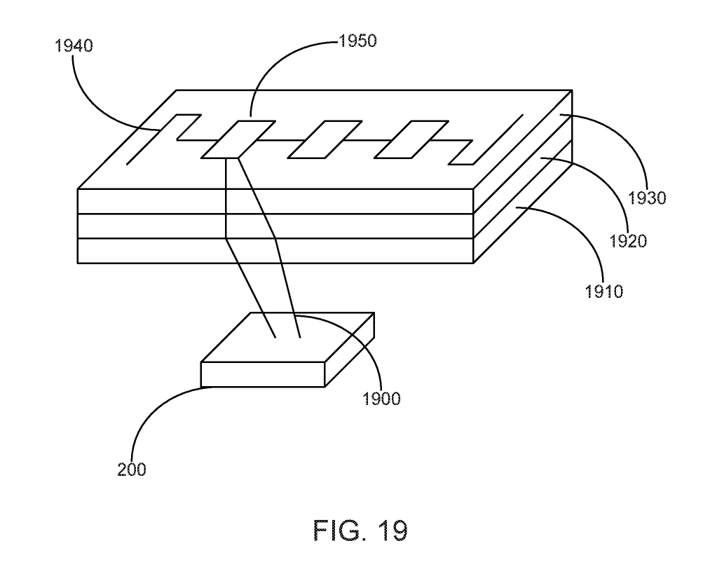

FIG. 19 shows a system for non-destructively testing a printed circuit board (PCB). The imaging system as described herein such as imaging system 200 may emit light 1900 configured to scatter within a first layer 1910, second layer 1920, third layer 1930, or any other layer (not shown) of a multi-layer PCB. The light may be configured to focus on an electrical trace (such as a wire) 1940 or a passive or active electronic component 1950 of the PCB. The imaging system may image the electrical trace or electronic component to determine whether it has been damaged. The imaging system may allow the imaging of electric currents within the electrical trace or electronic component. For instance, electro-optical interactions between electrons flowing the electrical trace or electronic component may induce slight changes to the phase conjugate computed by the imaging system compared to a state in which no current is flowing in the electrical trace or electronic component. Analyzing such changes may allow the local electronic environment to be determined within an electrical trace or electronic component.

The system can also be configured to measure voltage distributions across a PCB. For example, the system can be configured to measure the voltage of the PCB at predetermined locations, and the measured voltage can be compared to pre-defined values for each of the predetermined locations in order to determine whether the PCB is functioning properly. The system can be configured to map the voltage amounts in the PCB and compare values of the mapped voltage to target values in order to assess whether the PCB is functioning correctly. The system can also be configured to measure voltages of displays and other properties of displays such as optical properties in response to voltage, for example.

The systems and methods may be utilized to image through a variety of PCB materials. For instance, the systems and methods may be used to image through PCBS composed of woven glass and epoxy, phenolic cotton paper, cotton paper and epoxy, matte glass and polyester, non-woven glass and epoxy, or woven glass and epoxy. The systems and methods may be used to image through PCBs composed of G10, FR-2, FR-3, FR-4, FR-5, FR-6, CEM-1, CEM-1, CEM-3, CEM-4, or CEM-5 as is known to one of ordinary skill in the art. The systems and methods may be utilized to image through a silicon wafer to detect electronic components formed on the wafer. For instance, the systems and methods may be used to image through integrated circuits (ICs).

The systems and methods described herein may be utilized for 3D printing of optically translucent materials.

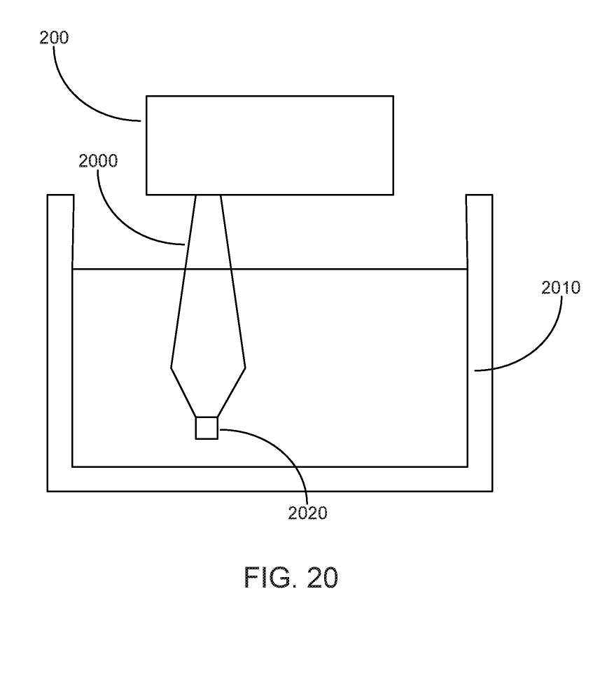

FIG. 20 shows a system for 3D printing of optically translucent materials. The imaging system as described herein such as imaging system 200 may emit light 2000 that is configured to scatter within an optical translucent photoactive liquid 2010 until the light is focused on a region 2020 that is to be exposed to light. The light may polymerize the photoactive liquid or optically induce other changes within the photoactive liquid that solidifies the photoactive liquid at the region 2020. By scanning the light to different regions of the photoactive liquid, a three-dimensional solid structure may be formed from the photoactive liquid. This may allow the use of materials that are typically difficult to use in 3D printing applications due to their lack of optical transparency. The region 2020 may have a cross-section that is no more than about 1 μm, no more than about 2 μm, no more than about 5 μm, no more than about 10 μm, no more than about 20 μm, no more than about 50 μm, or no more than about 100 μm across. The region 2020 may have a cross-section that is within a range defined by any two of the preceding values.

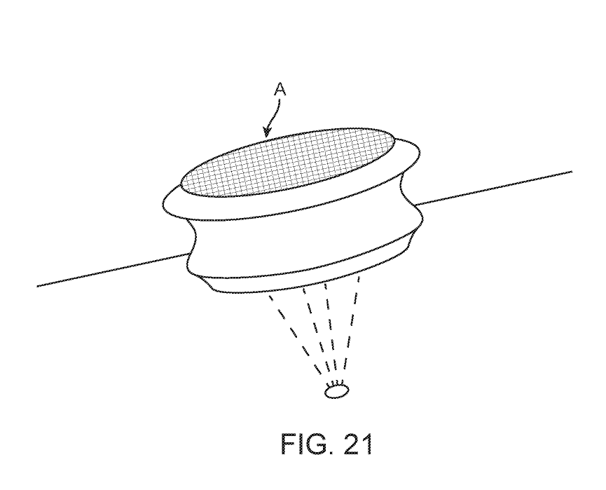

FIG. 21 shows a hand held device 2100 configured to view inside an object such as a body in 3D. The hand held device may comprise one or more components or features described herein, such as with reference to the puck integrated device as shown in FIGS. 12 and 15. The hand held device may comprise one or more components of the imaging systems as described herein, for example with reference to FIG. 1, 2, or 3. The hand held device can be placed on the skin of a subject. The device may comprise the optical imaging system located on a lower side of the device and a display on an upper side of the device. The imaging system can be configured to volumetrically scan voxels of a 3D material as described herein. The device can be used for many applications as described herein, such as human, medical, veterinary, carotid artery imaging, trauma, emergency medical technician (EMT), emergency room (ER), and field military triage for example. The display may comprise a full parallax light field display as is known to one of ordinary skill in the art. The features of the image shown on the display may be aligned with the features inside the body such that the features shown on the image appear at locations corresponding to the locations of the features within the body, for example. This can give the user the perception of looking directly into the body with the imaging device, and the imaged structures appear at their proper location as seen by the user. The position and orientation of the spatial light modulator such as the display module and the detector module such as the imaging module can be fixed in relation to the light field display in order to provide accurate registration of the imaged structure of the object with the light field display. The hand held device may comprise temperature and motion sensors as described herein, in order to provide temperature and motion compensated images on the light field display, for example. Although reference is made to light field display, the display may comprise a two dimensional touch screen display, for example.

The systems and methods described herein may be utilized to produce free space optical interconnects through scattering materials. For instance, the systems and methods may correct for scattering of light due to dust, water vapor, clouds, fog, rain, or other atmospheric materials which would tend to scatter a light beam.

The systems and methods described herein may be utilized for navigation in driverless vehicles. For instance, the systems and methods may correct for scattering of light due to fog or dust in the air, which may currently limit the performance of laser distance and ranging (LIDAR) and other optical sensing methods used for navigating driverless vehicles. The systems and methods may allow detection of objects located under water, such as submarines or sunken ships or airplanes. The submarines, sunken ships, or airplanes may be detected in a body of water, such as a lake, river, sea, or ocean, at a distance of at least about 10 meters, at least about 20 meters, at least about 50 meters, at least about 100 meters, at least about 200 meters, at least about 500 meters, or at least about 1,000 meters. The submarines, sunken ships, or airplanes may be detected in a body of water, such as a lake, river, sea, or ocean, at a distance that is within a range defined by any two of the preceding values. The systems and methods may allow detection of such objects by correcting for scattering of light due to water, such as sea water, such as sea water containing plankton.

The systems and methods described herein may be utilized for performing macromolecular sequencing operations. For instance, the systems and methods may be utilized to perform nucleic acid sequencing, gene sequencing, deoxyribonucleic acid (DNA) sequencing, ribonucleic acid (RNA) sequencing, protein sequencing, polypeptide sequencing, or peptide sequencing operations. The systems and methods may sequence DNA, RNA, proteins, polypeptides, or peptides. The systems and methods may be configured to perform gene sequencing by synthesis. The systems and methods may be configured to perform optical gene sequencing. The systems and methods may be configured to perform optical readout of sequencing by synthesis.

The systems and methods described herein may be utilized for the projection of images onto scattering materials in the atmosphere, such as dust or water vapor.

The systems and methods described herein may be utilized for safety applications. For instance, the systems and methods may be utilized to image the interiors of food products or their containers to ensure that the foods have not be tampered with or for quality control purposes. The systems and methods may be utilized to image foods such as milk, fruits, or vegetables The systems and methods may be utilized to image the interiors of medications or their containers to ensure that the medications have not be tampered with or for quality control purposes.

### Digital Processing Device

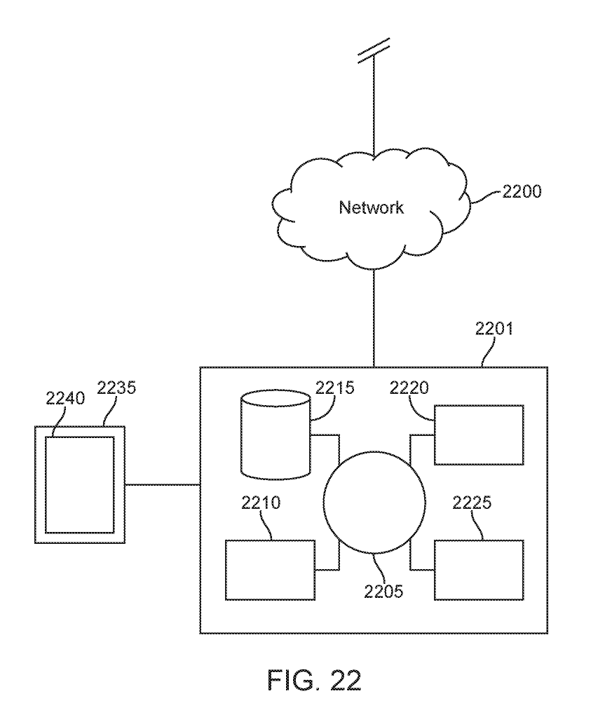

FIG. 22 illustrates an exemplary digital processing device 2201 programmed or otherwise configured with an imaging device, in accordance with some embodiments. In some embodiments, the platforms, systems, media, and methods described herein include a digital processing device, or use of the same. In further embodiments, the digital processing device includes one or more hardware central processing units (CPUs), general purpose graphics processing units (GPGPUs), or field programmable gate arrays (FPGAs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft Windows®, Apple Mac OS X®, UNIX °, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

Referring again to FIG. 22, an exemplary digital processing device 2201 is programmed or otherwise configured as an imaging device as described herein. The device 2201 can regulate various aspects of the imaging device of the present disclosure, such as, for example, performing processing steps. In this embodiment, the digital processing device 2201 includes a central processing unit (CPU, also “processor” and “computer processor” herein) 2205, which can be a single core or multi core processor, or a plurality of processors for parallel processing. The digital processing device 2201 also includes memory or memory location 2210 (e.g., random-access memory, read-only memory, flash memory), electronic storage unit 2215 (e.g., hard disk), communication interface 2220 (e.g., network adapter) for communicating with one or more other systems, and peripheral devices 2225, such as cache, other memory, data storage and/or electronic display adapters. The memory 2210, storage unit 2215, interface 2220 and peripheral devices 2225 are in communication with the CPU 2205 through a communication bus (solid lines), such as a motherboard. The storage unit 2215 can be a data storage unit (or data repository) for storing data. The digital processing device 2201 can be operatively coupled to a computer network (“network”) 2230 with the aid of the communication interface 2220. The network 2230 can be the Internet, an internet and/or extranet, or an intranet and/or extranet that is in communication with the Internet. The network 2230 in some cases is a telecommunication and/or data network. The network 2230 can include one or more computer servers, which can enable distributed computing, such as cloud computing. The network 2230, in some cases with the aid of the device 2201, can implement a peer-to-peer network, which may enable devices coupled to the device 2201 to behave as a client or a server.

Continuing to refer to FIG. 22, the CPU 2205 can execute a sequence of machine-readable instructions, which can be embodied in a program or software. The instructions may be stored in a memory location, such as the memory 2210. The instructions can be directed to the CPU 2205, which can subsequently program or otherwise configure the CPU 2205 to implement methods of the present disclosure. Examples of operations performed by the CPU 2205 can include fetch, decode, execute, and write back. The CPU 2205 can be part of a circuit, such as an integrated circuit. One or more other components of the device 2201 can be included in the circuit. In some cases, the circuit is an application specific integrated circuit (ASIC) or a field programmable gate array (FPGA).

Continuing to refer to FIG. 22, the storage unit 2215 can store files, such as drivers, libraries and saved programs. The storage unit 2215 can store user data, e.g., user preferences and user programs. The digital processing device 2201 in some cases can include one or more additional data storage units that are external, such as located on a remote server that is in communication through an intranet or the Internet.

Continuing to refer to FIG. 22, the digital processing device 2201 can communicate with one or more remote computer systems through the network 2230. For instance, the device 2201 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein can be implemented by way of machine (e.g., computer processor) executable code stored on an electronic storage location of the digital processing device 2201, such as, for example, on the memory 2210 or electronic storage unit 2215. The machine executable or machine readable code can be provided in the form of software. During use, the code can be executed by the processor 2205. In some cases, the code can be retrieved from the storage unit 2215 and stored on the memory 2210 for ready access by the processor 2205. In some situations, the electronic storage unit 2215 can be precluded, and machine-executable instructions are stored on memory 2210.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A focusing apparatus to focus light in a translucent material at a plurality of locations within the translucent material, the focusing apparatus comprising:
a detector comprising a plurality of detector pixels;
a first light source to direct a first light along an optical path;
a spatial light modulator coupled to the first light source to transmit modulated light to a location of the plurality of locations within the translucent material, the spatial light modulator comprising a first plurality of modulation pixels to modulate an amplitude or a phase of light transmitted to the location;
a second light source to direct a second light along an optical path of light received from the location to interfere with light received from the location, the detector arranged with the second light source to receive light from the translucent material and the second light source; and
a processor coupled to the detector and the spatial light modulator, wherein the processor is configured with instructions to adjust the first plurality of modulation pixels with a plurality of holographic patterns to focus light to each of the plurality of locations.

2. The focusing apparatus of claim 1, wherein the plurality of holographic patterns is configured to scan the light to the plurality of locations and optionally wherein the spatial light modulator remains substantially fixed in relation to the plurality of locations when the light is scanned to the plurality of locations.

3. The focusing apparatus of claim 1, wherein the plurality of holographic patterns comprises phase conjugates configured to focus the light at the plurality of locations and optionally wherein the plurality of holographic patterns correspond to optical power to focus the light to the plurality of locations.

4. The focusing apparatus of claim 1, wherein the plurality of holographic patterns correspond to sufficient optical power to focus the light to the plurality of locations at a plurality of distances from a the spatial light modulator and optionally wherein each of the plurality of distances comprises no more than a meter and the sufficient optical power comprises at least a Diopter and optionally wherein the sufficient optical power comprises at least 5 Diopters and optionally wherein the light is focused with the plurality of holographic patterns without a microscope objective lens.

5. The focusing apparatus of claim 1, wherein the plurality of holographic patterns comprises a phase conjugate for each of the plurality of locations and optionally wherein each of the plurality of phase conjugates comprises a predetermined phase conjugate stored on a memory of the processor and optionally wherein the processor comprises instructions to write the plurality of phase conjugates to the spatial light modulator.

6. The focusing apparatus of claim 1, wherein detector, the first light source, the spatial light modulator and the detector are arranged to increase an amount of light transmitted to the detector from the spatial light modulator in response to scattering of light within the translucent material.

7. The focusing apparatus of claim 1, wherein the spatial light modulator and the second light source are arranged at oblique angles to each other to increase an amount of light transmitted from the spatial light modulator to the detector in response to scatting of light within the translucent material.

8. The focusing apparatus of claim 1, wherein the first light source, the spatial light modulator, the second light source and the detector are arranged in sequence with the plurality of locations disposed between the spatial light modulator and the second light source.

9. The focusing apparatus of claim 8, wherein an optical axis of the spatial light modulator and an optical axis of the second light source are arranged at oblique angles to each other and coupled to an object at a plurality of spaced apart locations to receive scattered light from the object and optionally wherein the object comprises a patient.

10. The focusing apparatus of claim 9, further comprising a modulator module comprising the first light source and the spatial light modulator and a detector module comprising the second light source and the detector, and wherein the modulator module and the detector module are located at the plurality of spaced apart locations.

11. The focusing apparatus of claim 10, further comprising a plurality of modulator modules and a plurality of detector modules coupled to the object at a plurality of at least four spaced apart locations and wherein the plurality of modules is coupled to the object to focus light to the plurality of locations within the object.

12. The focusing apparatus of claim 11, wherein the plurality of modulator modules and the plurality of detector modules are coupled to the processor in a network configuration.

13. The focusing apparatus of claim 1, wherein the first light source and the spatial light modulator are arranged in a first sequence and oriented to direct light toward the plurality of locations along an axis extending from the spatial light modulator toward the plurality of locations, and wherein the second light source and the detector are arranged and oriented in a second sequence away from the axis in order to receive forward scattered light transmitted obliquely from the plurality of locations and away from the axis and optionally wherein the forward scattered light transmitted through the material to the detector corresponds to a curved energy profile distribution and optionally wherein the curved energy profile distribution corresponds to a banana like shape.

14. The focusing apparatus of claim 1, wherein the first light source and the spatial light modulator are oriented toward the plurality of locations to direct light toward the plurality of locations along an optical path, and wherein the second light source and the detector are arranged in sequence with the plurality of locations disposed between the spatial light modulator and the second light source.

15. The focusing apparatus of claim 1, wherein the detector, first light source, the spatial light modulator and the second light source are arranged in sequence with the plurality of locations disposed on an opposite side of the second light source from the spatial light modulator in order to receive backscattered light from the translucent material.

16. The focusing apparatus of claim 1, wherein the wavelength is within a range from about 700 nm to about 900 nm.

17. The focusing apparatus of claim 1, wherein the translucent material comprises a scattering coefficient (μₛ) within a range from about 5 cm−1 to about 50 cm−1.

18. The focusing apparatus of claim 1, wherein the focusing apparatus is configured to focus light at the plurality of locations to a maximum cross-sectional dimension within a range from about 1 um to about 10 mm.

19. The focusing apparatus of claim 1, wherein the spatial light modulator comprises a number of pixels within a range from 1,000,000 pixels to 100,000,000 pixels.

20. The focusing apparatus of claim 1, wherein the detector comprises a number of pixels within a range from 1,000,000 pixels to 100,000,000 pixels.

21. The focusing apparatus of claim 1, wherein the focusing apparatus comprises a weight within a range from about 15 grams to about 1 kg.

22. The focusing apparatus of claim 1, wherein the focusing apparatus comprises a component of an imaging system configured to generate an image of the translucent material.

23. The focusing apparatus of claim 1, wherein the focusing apparatus is configured to focus light at the plurality of locations to a maximum cross-sectional dimension within a range extending between any two of the following 100 nm, 200 nm, 500 nm, 1 um, 2 um, 5 um, 10 um, 20 um, 50 um, 100 um, 200 um, 500 um, 1 mm, 2 mm, 5 mm, or 10 mm.

24. The focusing apparatus of claim 1, wherein the spatial light modulator comprises a number of pixels within a range extending between any two of the following, 1,000,000 pixels, 2,000,000 pixels, 5,000,000 pixels, 10,000,000 pixels, 20,000,000 pixels, 50,000,000 pixels, 100,000,000 pixels, 200,000,000 pixels, or 500,000,000 pixels.

25. The focusing apparatus of claim 1, further comprising a second spatial light modulator and wherein the second spatial light modulator comprises a number of pixels within a range extending between any two of the following, 1,000,000 pixels, 2,000,000 pixels, 5,000,000 pixels, 10,000,000 pixels, 20,000,000 pixels, 50,000,000 pixels, 100,000,000 pixels, 200,000,000 pixels, or 500,000,000 pixels.

26. The focusing apparatus of claim 1, wherein the detector comprises a number of pixels within a range extending between any two of the following, 1,000,000 pixels, 2,000,000 pixels, 5,000,000 pixels, 10,000,000 pixels, 20,000,000 pixels, 50,000,000 pixels, 100,000,000 pixels, 200,000,000 pixels, or 500,000,000 pixels.

27. The focusing apparatus of claim 1, wherein a volume of the material scanned comprises a volume within a range extending between any two of the following 1 mm³, 10 mm³, 20 mm³, 50 mm³, 100 mm³, 200 mm³, 500 mm³, 1 cm³, 2 cm³, 5 cm³, 10 cm³, 20 cm³, 50 cm³, 100 cm³, 100 cm³, 200 cm³, 1000 cm³, 2000 cm³, 5000 cm³, 10,000 cm³, 20,000 cm³, 50,000 cm³, 100,000 cm³, 200,000 cm³, 500,000 cm³, or 1 m³.

28. The focusing apparatus of claim 1, wherein a number of voxels along each dimension of a 3D image is within a range from about 200 to about 5,000 and optionally wherein a number of voxels along each dimension is within a range defined by any two of the following 200, 500, 1000, 2000, 5000, 10,000, 20,000 or 50,000.

29. The focusing apparatus of claim 1, wherein a spatial light modulator module comprising the first light source and the spatial light modulator and an imaging module comprising the second light source and the detector comprises a weight within a range extending between any two of the following 10 grams, 20 grams, 50 grams, 100 grams, 200 grams, 500 grams, 1 kg, 2 kg, 5 kg or 10 kg and optionally wherein the detector module and the imaging module a weight within a range from about 15 g to about 1 kg.

30. The focusing apparatus of claim 1, wherein the translucent material comprises a scattering coefficient (μₛ) within a range extending between any two of the following 1 cm−1, 2 cm−1, 5 cm−1, 10 cm−1, 20 cm−1, 50 cm−1, 100 cm−1, 500 cm−1, 1000 cm−1, 2000 cm−1, 5000 cm−1.

31. The focusing apparatus of claim 1, wherein the first light source is coupled to a first emitter and the second light source is coupled to a second emitter.

32. (canceled)

33. The focusing apparatus of claim 1, wherein the first light source and the second light source are coupled to an emitter.

34. The focusing apparatus of claim 1, wherein the first light source comprises a first light director and optionally wherein the first light director is selected from a group consisting of a light guide light plate, a slim prism, a diffractive grating, a saw tooth grating, cascaded beam splitters, a set of tandem glued beamsplitters of various reflectances and transmittances cascaded together to create a tiled beam perpendicular to the array of prisms, a pupil expander, a plurality of micro LEDs and a lenslet array and optionally wherein the first light source comprises a plurality of micro LEDs coupled to the spatial light modulator.

35. The focusing apparatus of claim 1, wherein the second light source comprises a second light director and optionally wherein the second light director is selected from a group consisting of a light guide light plate, a slim prism, a diffractive grating, a saw tooth grating, cascaded beam splitters, a set of tandem glued beamsplitters of various reflectances and transmittances cascaded together to create a tiled beam perpendicular to the array of prisms, a pupil expander, a plurality of micro LEDS and a lenslet array and optionally wherein the second light source comprises a plurality of micro LEDs.

36. The focusing apparatus of claim 1, wherein the processor is configured to form an image of the material with a resolution within a range from about 1 mm to about 5 mm and optionally wherein the focusing apparatus is configured to move in relation to the plurality of locations a distance of at least about 10 cm in order to image a volume of the material larger than a field of view of the detector and optionally wherein the distance comprises at least about 20 cm and optionally wherein the object comprises tissue of a patient and wherein the distance corresponds to a distance of the patient and optionally wherein the distance corresponds to a height of the patient in order to perform a whole body scan of the patient and optionally wherein the focusing apparatus is configured to translate or rotate.

37. The focusing apparatus of claim 1, wherein the spatial light modulator is separated from the first light source by a distance of no more than about 10 mm and optionally wherein the spatial light modulator comprises a transmissive spatial light modulator.

38. The focusing apparatus of claim 1, wherein the second light source is separated from the detector by a distance of no more than about 10 mm and optionally wherein the spatial light modulator comprises a transmissive spatial light modulator.

39. The focusing apparatus of claim 1, wherein the translucent material is selected from a group consisting of atmospheric material, fog, rain, water, sea water, sea water comprising plankton, printed circuit board material, printed circuit board material comprising woven glass and epoxy, printed circuit board material comprising phenolic cotton paper, printed circuit board material comprising cotton paper and epoxy, printed circuit board material comprising matte glass and polyester, printed circuit board material comprising non-woven glass and epoxy, woven glass and polyester, layers of plastic, plastic, 3D printing fluid, a photoactive liquid, concrete, stone, brick, wood, sheetrock, thermal insulation, plastic piping, polyvinyl chloride, fiberglass, paint, food, milk, fruit, vegetables, bone, tissue, neural tissue, breast tissue, prostate tissue, testicular tissue, tissue of the vas deferens, urethral tissue, ocular tissue, retinal tissue, rectal tissue, stomach tissue, colon tissue, cervical tissue, endometrial tissue, or uterine tissue.

40. The focusing apparatus of claim 1, wherein the light comprises a wavelength selected from a group consisting of ultraviolet light, visible light, infrared light, near infrared light, and mid infrared light.

41. The focusing apparatus of claim 40, wherein the ultraviolet light comprises a wavelength within a range from about 200 nm to about 380 nm, the visible light comprises a wavelength within a range from about 380 nm to about 760 nm, the infrared light comprises a wavelength within a range from about 760 nm to about 6 um, the near infrared light comprises a wavelength within a range from about 750 nm to about 2.5 um, the mid infrared light comprises a wavelength within a range from about 2.5 um to about 10 um.

42. The focusing apparatus of claim 1, wherein the spatial light modulator or a second spatial light modulator comprises a liquid crystal material for each of the plurality of modulator pixels.

43. The focusing apparatus of claim 1, wherein the spatial light modulator or a second spatial light modulator comprises a reflective surface for each of the plurality of pixels.

44. The focusing apparatus of claim 1, further comprising a 3D printer configured to deposit a material in response to light, wherein the 3D printer comprises a translucent liquid material through which light modulated with the spatial light modulator reacts to form an object and optionally wherein the light beam is focused to a cross section of no more than about 10 um across.

45. The focusing apparatus of claim 1, wherein the spatial light modulator is configured to focus light and write a pattern on a retina of an eye from a temple or a forehead of a subject, and optionally wherein the focusing apparatus is configured to write on both eyes of the subject and optionally wherein the device is configured write the pattern on a neural layer above cones of the eye.

46. The focusing apparatus of claim 1, further comprising a support configured to support the focusing apparatus on a head of a subject and optionally wherein the support comprises a hat.

47. The focusing apparatus of claim 1, further comprising an optically transmissive flexible support structure to support an object to be imaged, and wherein the optically transmissive flexible support structure is configured to receive and conform to the shape of the object on a first side in order to optically couple to the object to be imaged, and wherein the spatial light modulators, the detector and the light sources are located on a second side of the optically transmissive flexible support structure and optionally wherein the optically transmissive flexible support structure comprises a transparent sheet of material.

48. The focusing apparatus of claim 47, wherein the object to be imaged comprises a portion of a subject and optionally wherein the optically transmissive flexible support structure is configured to receive at least about half of the weight of the subject and optionally wherein the object comprises a foot of the a patient.

49. The focusing apparatus of claim 47, wherein the optically transmissive flexible support structure comprises a flexible membrane and optionally wherein the membrane comprises plastic.

50. The focusing apparatus of claim 47, further comprising a chamber to contain a liquid on the second side of the optically transmissive flexible support structure and wherein the detector and spatial light modulators are configured to move within the liquid in order to image an area of the object larger than the field of view of the detector and optionally wherein the chamber comprises a sealed chamber and the optically transmissive flexible support structure comprises a material substantially impermeable to a sanitizer.

51. The focusing apparatus of claim 47, wherein the support structure comprises a chair and optionally wherein the detector and light sources are configured to translate within the chair in order to image an area of the object larger than a field of view of the detector and optionally wherein the focusing apparatus is configured for pelvic imaging to detect colorectal cancer, prostate cancer, or uterine cancer.

52. The focusing apparatus of claim 1, further comprising a head mounted support coupled to the detector to support the first light source and the second light source and the spatial light modulator with a head of a patient, and wherein the focusing apparatus is configured to couple to a brain of the patient to receive commands from the patient and optionally wherein the head mounted support comprises a hat or band.

53. The focusing apparatus of claim 52, further comprising a wheel chair, a scooter, a speech synthesizer or a car and configured to receive the commands in order to control the wheel chair, the scooter, the speech synthesizer or the car.

54. The focusing apparatus of claim 1, further comprising an augmented reality interface configured to display an image of an internal structure of an object at the plurality of locations of the object as seen by a user.

55. The focusing apparatus of claim 54 optionally further comprising a display of a mobile device and sensors coupled to the mobile device configured to determine a position and orientation of the display and optionally wherein the position and orientation of the display comprises 6 degrees of freedom comprising three translational degrees of freedom and 3 rotational degrees of freedom in order to register the image shown on the display with the plurality of locations of the object in a body as seen by the user and optionally wherein the mobile device comprises a tablet or goggles.

56. The focusing apparatus of claim 54, wherein the detector is coupled to sensors to determine the position and orientation of the detector in 6 degrees of freedom in order to register the image on the display with the plurality of locations of the object, wherein the object comprises a tissue.

57. The focusing apparatus of claim 54, wherein the detector is coupled to sensors to determine the position and orientation of the detector in 6 degrees of freedom in order to register the image on the display with the plurality of locations of the object, wherein the object comprises a tissue and optionally wherein the mobile device comprises a tablet.

58. The focusing apparatus of claim 54, wherein the object is a patient, further comprising a detector to measure a plurality of locations of a head of the patient in order to register the image shown on the display with the plurality of locations of the head of the patient such that the image that appears on the display corresponds to physical locations of the plurality of locations of the head of the patient.

59. The focusing apparatus of claim 54, wherein the internal structure of the object comprises a two dimensional image, a three dimensional image, an augmented reality image, or a stereoscopic image and optionally further comprising viewing goggles to view the object with three dimensional depth information.

60. The focusing apparatus of claim 54, wherein the display comprises an optically transmissive display to view the internal structure and the object being imaged with augmented reality.

61. (canceled)

62. The focusing apparatus of claim 54, further comprising sensors to measure a position and orientation of an imaging apparatus coupled to the object, and wherein the sensors comprise machine readable icons, magnetic, or optical sensors to capture the position and orientation of the object.

63. The focusing apparatus of claim 54, wherein the focusing apparatus is configured to be held in a hand of a user, the apparatus comprising a display on a first side and an optically transmissive structure on a second side to optically couple to an object, wherein the processor comprises instructions to display an image of an internal structure of the subject on the display when the second side is optically coupled to a skin of the subject.

64. The focusing apparatus of claim 1, wherein the focusing apparatus is configured to be held in a hand of a user, the apparatus comprising a display on a first side and an optically transmissive structure on a second side to optically couple to an object, wherein the processor comprises instructions to display an image of an internal structure of the object on the display when the second side is optically coupled to a surface of the object.

65. The focusing apparatus of claim 64, wherein the display comprises a light field display configured to display internal structure of the object in 3D.

66. The focusing apparatus of claim 64, wherein the display comprises a light field display configured to display internal structure of the object in 3D and optionally display the image with full 3D parallax and wherein the image comprises a 3D image.

67. The focusing apparatus of claim 64, wherein the display is configured to display a plurality of structures of the object at a plurality of locations on the display corresponding to the plurality of locations of the structure within the object such that a plurality of virtual locations of the structure is aligned with the plurality of locations of the plurality of structures as seen by the user.

68. The focusing apparatus of claim 64, wherein the display is configured to display structure of the object at a location on the display corresponding to the location of the structure within the object

69. The focusing apparatus of claim 64, wherein the display is configured to display the internal structure with a resolution of 1 mm or finer than one 1 mm and optionally wherein the resolution shown on the display corresponds to a resolution of the structure within a range from about 1 um to about 1 mm and optionally wherein the resolution shown on the display corresponds to a resolution of the structure within a range from about 5 um to about 100 um.

70. The focusing apparatus of claim 64, wherein the hand held apparatus comprises a maximum dimension across of no more than about 15 cm and a thickness transverse to the maximum dimension across, the thickness no more than about 10 cm and wherein the hand held apparatus weighs no more than about 1 kg.

71. The focusing apparatus of claim 64, wherein the object comprises a mammal, and wherein the focusing apparatus is configured to measure a carotid artery and optionally wherein the mammal comprises a human, an animal, a patient, a veterinary patient, or a human patient.

72. The focusing apparatus of claim 64, wherein the focusing apparatus is configured for veterinary use, trauma patients, emergency medical technicians, emergency room use, or field military triage.

73. The focusing apparatus of claim 1, wherein the focusing apparatus is configured to deliver focused light for therapy selected from a group consisting of photodynamic therapy and neurostimulation.

74. The focusing apparatus of claim 1, wherein the focusing apparatus is configured to emit light into the object with an energy density comprising no more than 10 mW/cm2.

75. The focusing apparatus of claim 1, wherein the focusing apparatus is configured to emit light into the object with an energy density comprising at least 10 mW/cm2 and optionally within a range from 10 mW/cm2 to 50,000 mW/cm2 and optionally wherein the range is from 11 mW/cm2 to 50,000 mW/cm2.

76. The focusing apparatus of claim 1, wherein the focusing apparatus is configured to measure a temperature at the plurality of locations.

77. The focusing apparatus of claim 1, wherein the detector comprises a non-silicon detector configured to measure black body radiation emitted from an object having a temperature within a range from about 100 degrees K to about 400 degrees K.

78. The focusing apparatus of claim 1, wherein the focusing apparatus is configured to perform light detection and ranging (LIDAR) and determine a distance to an object through an atmosphere and optionally wherein the distance is determined in response to a plurality of intensities at the plurality of locations.

79. The focusing apparatus of claim 1, wherein the focusing apparatus is configured to perform optical gene sequencing, gene sequencing by synthesis, or optical readout sequencing by synthesis.

80. The focusing apparatus of claim 1, wherein the focusing apparatus is configured to sequence proteins.

81. The focusing apparatus of claim 1, wherein the focusing apparatus is configured to detect a submarine in an ocean at a distance of at least about 100 meters.

82. The focusing apparatus of claim 1, wherein the plurality of locations comprise locations of an image volume and wherein the image volume comprises a maximum dimension across and wherein the spatial light modulator comprises a maximum dimension across and wherein the maximum dimension across the image volume comprises at least about 10% of a maximum dimension across the spatial light modulator, and optionally wherein the maximum distance across the image volume along an axis parallel to the spatial light modulator comprises at least about 20%, 50%, or 100% of the distance across the spatial light modulator and optionally wherein the maximum dimension across the image volume parallel to the spatial light modulator is within a range defined by any two of the following 10%, 20%, 50%, 75% or 100%.

83. The focusing apparatus of claim 1, wherein the processor comprises instructions to generate an image of light focused at each of the plurality of locations and optionally wherein the processor is configured with instructions to generate a plurality of interference patterns on the detector at said plurality of locations and to generate the plurality of images in response to said plurality of interference patterns and optionally wherein each of the plurality of images comprises spatial frequencies greater than spatial frequencies corresponding to a focused size of the light at said each location.

84. The focusing apparatus of claim 1, wherein the processor comprises instructions to generate a 3D volumetric image comprising a plurality of voxels in response to a plurality of light beams focused to a plurality of 3D locations of a 3D volume of the translucent material and optionally wherein the plurality of voxels comprises a number greater than the plurality of locations and optionally wherein the 3D volumetric image comprises spatial frequencies greater than spatial frequencies corresponding to a focused size of the light at the plurality of locations.

85. An focusing apparatus to focus light in a translucent material at a location within the translucent material, the focusing apparatus comprising:
a detector comprising a plurality of detector pixels;
a first light source to direct a first light along an optical path;
a spatial light modulator coupled to the first light source to transmit modulated light to the location within the translucent material, the spatial light modulator comprising a plurality of modulation pixels to modulate an amplitude or a phase of light transmitted to the location;
a second light source to direct a second light along an optical path of light received from the location to interfere with light received from the location, the detector arranged with the second light source to receive light from the translucent material and the second light source; and
a processor coupled to the detector and the spatial light modulator, wherein the processor is configured with instruction to adjust the amplitude or phase of the plurality of modulation pixels to focus light at the location.

86. The focusing apparatus of claim 85, wherein the processor comprises instructions to generate a 3D image of a volume of tissue at the location.
